(19) United States
(12) Patent Application Publication
(10) Pub. No.: US 2026/0164162 A1
(43) Pub. Date: Jun. 11, 2026

(54) Gesture-Based Control Using Active Acoustic Sensing

(71) Applicant: Google LLC, Mountain View, CA (US)

(72) Inventors: Patrick M. Amihood, Palo Alto, CA (US); Xiaoran Fan, Irvine, CA (US)

(73) Assignee: Google LLC, Mountain View, CA (US)

(21) Appl. No.: 19/150,111

(22) PCT Filed: Dec. 29, 2023
(86) PCT No.: PCT/US2023/086447

§ 371 Date: Jul. 22, 2025

Related U.S. Application Data
(60) Provisional application No. 63/490,657, filed on Mar. 16, 2023.

(51) Int. Cl. H04R 1/10; G06F 3/16; G06Q 20/32; H04R 3/02

(52) U.S. Cl. CPC H04R 1/1041; G06F 3/165; G06F 3/167; G06Q 20/321; H04R 1/1016; H04R 3/02; H04R 2420/07; H04R 2430/01; H04R 2460/01

(57) ABSTRACT

Techniques and apparatuses are described that perform gesture-based control using active acoustic sensing. By transmitting and receiving acoustic signals, a hearable can recognize changes in an acoustic circuit to perform gesture recognition. Gesture recognition involves recognizing a muscle-based gesture and/or an object-based gesture. With gesture recognition, the hearable can support a voice-free and/or hands-free user interface that enables the user to control an operation of the hearable or a computing device that is coupled to the hearable. This voice-free and/or hands-free user interface can provide a discreet and socially acceptable means of controlling an electronic device in a variety of different environments. It can also provide additional accessibility for people with various disabilities or physical restrictions.

### BACKGROUND

Wireless technology has become prevalent in everyday life, making communication and data readily accessible to users. One type of wireless technology are wireless hearables, examples of which include wireless earbuds and wireless headphones. Wireless hearables have allowed users freedom of movement while listening to audio content from music, audio books, podcasts, and videos. With the prevalence of wireless hearables, there is a market for adding additional features to existing hearables without introducing any hardware changes.

### SUMMARY

Techniques and apparatuses are described for gesture-based control using active acoustic sensing. By transmitting and receiving acoustic signals, a hearable can recognize changes in an acoustic circuit to perform gesture recognition. Gesture recognition involves recognizing a gesture in which a user engages their muscles to move one or more parts of their upper body or uses an object to interact with the one or more parts of their upper body. With gesture recognition, the hearable can support a voice-free and hands-free user interface that enables the user to control an operation of the hearable and/or control an operation of a computing device that is coupled to the hearable. This voice-free and hands-free user interface can provide a discreet and socially acceptable means of controlling a device in a variety of different environments. It can also provide additional accessibility for people with various disabilities and/or physical restrictions.

Aspects described below include a method for performing gesture-based control using active acoustic sensing. The method includes transmitting, during a first time period, an acoustic transmit signal that propagates within at least a portion of an ear canal of a user. The method also includes receiving, during the first time period, an acoustic receive signal. The acoustic receive signal represents a version of the acoustic transmit signal with one or more waveform characteristics modified based on the propagation within the ear canal and based on a gesture performed by the user during the first time period. The gesture is associated with the user moving and/or interacting one or more parts of their upper body. The method additionally includes recognizing the gesture based on the one or more modified waveform characteristics of the acoustic receive signal. The method further includes controlling an operation of at least one device based on the recognized gesture. For example, the recognized gesture may be used to control an operation of a hearable (e.g., a hearable used for transmitting the acoustic transmit signal) and/or an operation of a computing device that is coupled to a hearable.

Aspects described below include a computer-readable storage medium comprising instructions that, responsive to execution by a processor, cause a hearable to perform any one of the methods described herein.

Aspects described below include a device with at least one transducer and at least one processor. The device is configured to perform, using the at least one transducer and the at least one processor, any one of the methods described herein.

Aspects described below include a system with means for performing gesture-based control using active acoustic sensing.

### BRIEF DESCRIPTION OF DRAWINGS

Apparatuses for and techniques that perform gesture-based control using active acoustic sensing are described with reference to the following drawings. The same numbers are used throughout the drawings to reference like features and components:

FIG. 1-1 illustrates an example environment in which active acoustic sensing can be implemented;

FIG. 1-2 illustrates an example geometric change in an ear canal, which can be detected using active acoustic sensing;

FIG. 2-1 illustrates an example environment in which gesture-based control using active acoustic sensing can be implemented;

FIG. 2-2 illustrate another example environment in which gesture-based control using active acoustic sensing can be implemented;

FIG. 3 illustrates example mappings of input primitives to controls;

FIG. 4 illustrates example components of a computing device;

FIG. 5 illustrates example components of a hearable;

FIG. 6 illustrates example operations of two hearables;

FIG. 7 illustrates an example implementation of a hearable capable of performing gesture-based control using active acoustic sensing;

FIG. 8 illustrate an example implementation of a pre-processing module for performing active acoustic sensing;

FIG. 9 illustrates an example scheme for performing gesture-based control;

FIG. 10 illustrates example communications between a gesture-recognition module and a gesture-based control module;

FIG. 11-1 illustrates example audioplethysmography signals associated with a first muscle-based gesture involving jaw movement;

FIG. 11-2 illustrates example audioplethysmography signals associated with a second muscle-based gesture involving jaw movement;

FIG. 12-1 illustrates example audioplethysmography signals associated with a third muscle-based gesture involving jaw movement with a closed mouth;

FIG. 12-2 illustrates example audioplethysmography signals associated with a third muscle-based gesture involving jaw movement with an open mouth;

FIG. 13-1 illustrates example audioplethysmography signals associated with a fourth muscle-based gesture involving tongue movement with a closed mouth;

FIG. 13-2 illustrates example audioplethysmography signals associated with a fourth muscle-based gesture involving tongue movement with an open mouth;

FIG. 14 illustrates example audioplethysmography signals associated with a fifth muscle-based gesture involving eyelid movement;

FIG. 15 illustrates example audioplethysmography signals associated with a first object-based gesture involving a tap;

FIG. 16 illustrates example audioplethysmography signals associated with a second object-based gesture involving a push;

FIG. 17 illustrates an example method for performing an aspect of gesture-based control using active acoustic sensing;

FIG. 18 illustrates another example method for performing an aspect of gesture-based control using active acoustic sensing; and

FIG. 19 illustrates an example computing system embodying, or in which techniques may be implemented that enable use of, gesture-based control using active acoustic sensing.

### DETAILED DESCRIPTION

Wireless technology has become prevalent in everyday life, making communication and data readily accessible to users. One type of wireless technology are wireless hearables, examples of which include wireless earbuds and wireless headphones. Wireless hearables have allowed users freedom of movement while listening to audio content from music, audio books, podcasts, and videos. With the prevalence of wireless hearables, there is a market for adding additional features to existing hearables without introducing any hardware changes.

To improve aesthetics and reduce encumbrance, it is desirable to design wireless hearables with smaller sizes. As space becomes limited, however, it can be challenging to integrate additional components within the wireless hearables. It can also become difficult to use a touch user interface (TCI) to control an operation of the hearable.

Some hearables can address this by supporting a voice user interface (VCI). Although voice-based interactions can facilitate control of the hearable, voice commands are often lengthy and users have to pronounce key words before providing a voice command. In some contexts, such as in quiet places and during conversations, it might be inappropriate or awkward to utilize voice commands. Also, in extremely noisy environments, voice commands may be challenging to detect and/or recognize. It is therefore desirable to provide a hands-free and voice-free user interface with hearables.

Provided according to one or more preferred embodiments is a hearable, such as an earbud, that is capable of performing a novel physiological monitoring process termed herein audioplethysmography. Audioplethysmography is an active acoustic method capable of sensing subtle physiologically-related changes observable at a user's outer and middle ear. Instead of relying on other auxiliary sensors, such as optical or electrical sensors, audioplethysmography involves transmitting and receiving acoustic signals that at least partially propagate within a user's ear canal. To perform audioplethysmography, the hearable forms at least a partial seal in or around the user's outer ear. This seal enables formation of an acoustic circuit, which includes the seal, the hearable, the ear canal, and an ear drum of the ear. By transmitting and receiving acoustic signals, the hearable can recognize changes in the acoustic circuit to perform gesture recognition. Gesture recognition involves recognizing a gesture in which the user engages their muscles to move one or more parts of their upper body or the user uses an object (e.g., a stylus or an appendage) to interact with the one or more parts of their upper body.

With gesture recognition, the hearable can support a voice-free and hands-free user interface that enables the user to control an operation of the hearable and/or control an operation of a computing device that is coupled to the hearable. This voice-free and hands-free user interface can provide a discreet and socially acceptable means of controlling a device in a variety of different environments. It can also provide additional accessibility for people with various disabilities and/or physical restrictions. In addition to being relatively unobtrusive, some hearables can be configured to support muscle-based-gesture recognition without the need for additional hardware. As such, the size, cost, and power usage of the hearable can help make muscle-based-gesture recognition accessible to a larger group of people and improve the user experience with hearables.

The described techniques for performing gesture recognition using active acoustic sensing can provide enhanced performance relative to other sensing techniques. Active acoustic sensing involves transmitting an acoustic signal. The transmitted acoustic signal can have a predetermined set of frequencies to increase frequency diversity and improve signal-to-noise ratio performance for muscle-based-gesture recognition. By controlling and customizing characteristics of the transmitted acoustic signal, active acoustic sensing can provide a higher quality signal for gesture recognition compared to passive acoustic sensing techniques, which do not control characteristics of a transmitted signal. Furthermore, passive acoustic sensing techniques can be sensitive to interference caused by other signals in the environment, such as the audio content presented by the hearable.

Active acoustic sensing can also provide improved performance for detecting gestures compared to other sensors, such as a microphone or a motion sensor (e.g., an inertial measurement unit). Audible signals received by the microphone, for instance, can be subjected to noise caused by vibrations that occur while audio content is presented by the hearable. As such, it can be challenging to distinguish between these vibrations and indications of the gestures. Furthermore, audible signals that are received by the microphone may have wavelengths that are not ideal for detecting a gesture. In contrast, the frequencies used for active acoustic sensing, which include ultrasound frequencies, can have wavelengths that are sufficiently short for detecting small changes that occur within the ear canal as the gesture is performed.

It can also be challenging to utilize the motion sensor to detect gestures. In one aspect, the motion sensor may not be optimally positioned to detect smaller gestures. Furthermore, the motion sensor may be limited in the variety of gestures that it can recognize. Additionally, the motion sensor can experience poor performance while the user is performing an activity and moving. In this case, the overall motion of the user can mask smaller movements caused by the gesture. In contrast to the microphone and the motion sensor, active acoustic sensing can support gesture recognition while audio content is presented by the hearable and/or while the user is moving.

### Operating Environment

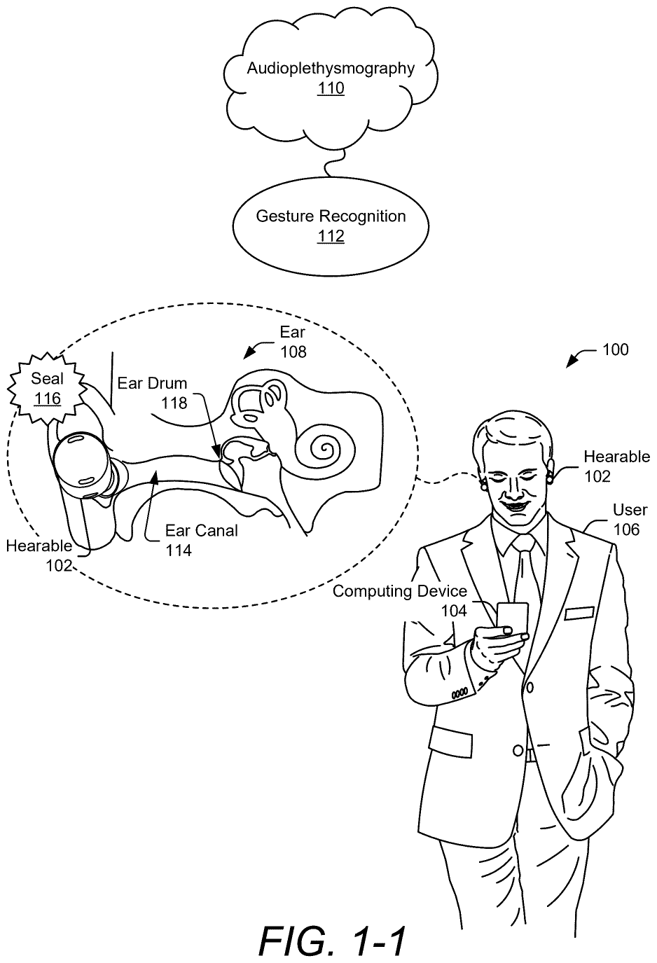

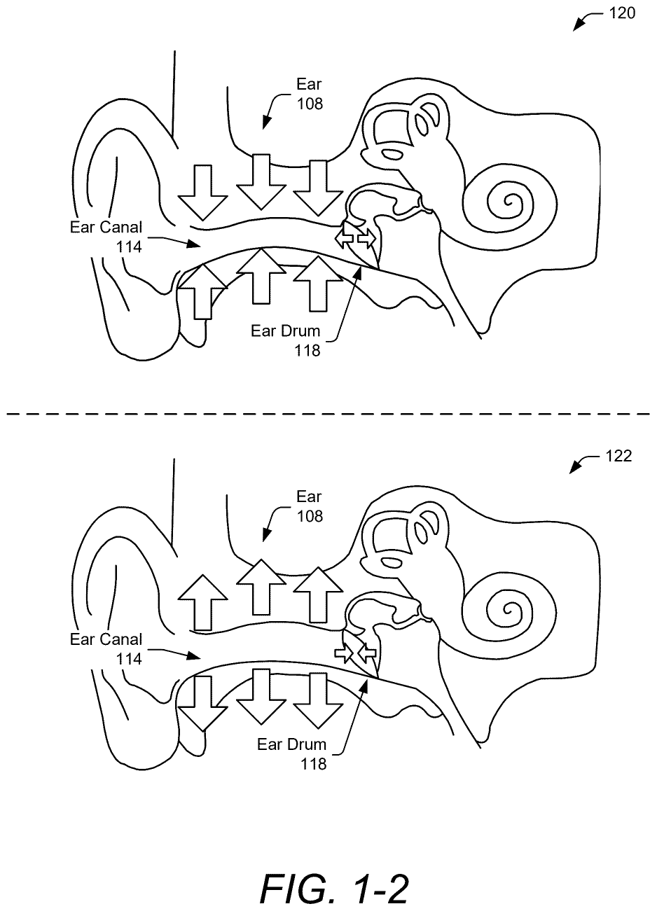

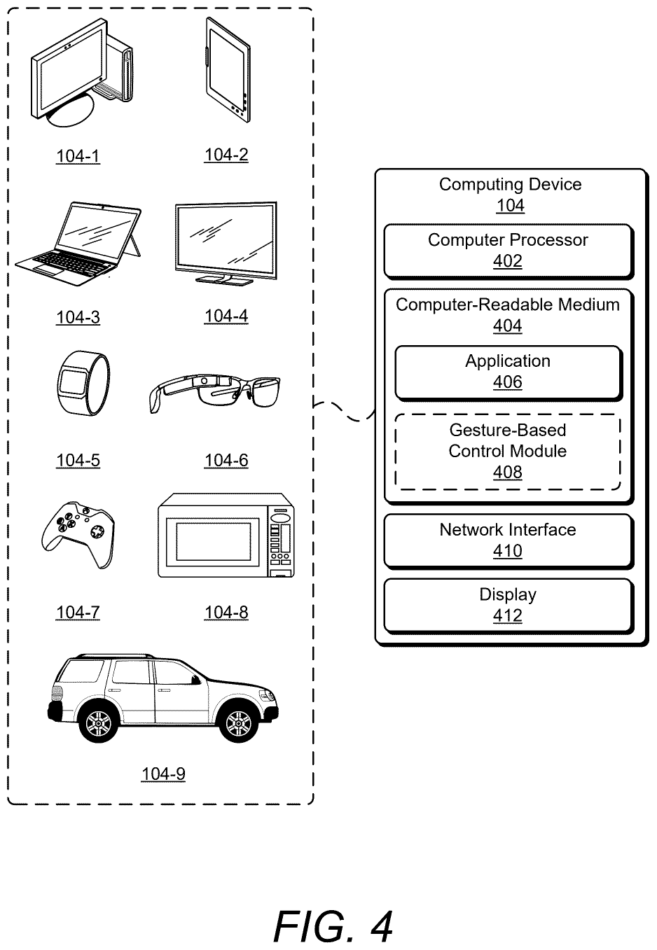

FIG. 1-1 is an illustration of an example environment 100 in which active acoustic sensing can be implemented. In the example environment 100, a hearable 102 is connected to a computing device 104 using a physical or wireless interface. The hearable 102 is a device that can play audible content provided by the computing device 104 and direct the audible content into a user 106's ear 108. In this example, the hearable 102 operates together with the computing device 104. In other examples, the hearable 102 can operate or be implemented as a stand-alone device. Although depicted as a smartphone, the computing device 104 can include other types of devices, including those described with respect to FIG. 4.

The hearable 102 is capable of performing audioplethysmography 110, which is an active acoustic method of sensing that occurs at the ear 108. The hearable 102 can perform this sensing without the use of other auxiliary sensors, such as an optical sensor or an electrical sensor. Through audioplethysmography 110, the hearable 102 can perform gesture recognition 112.

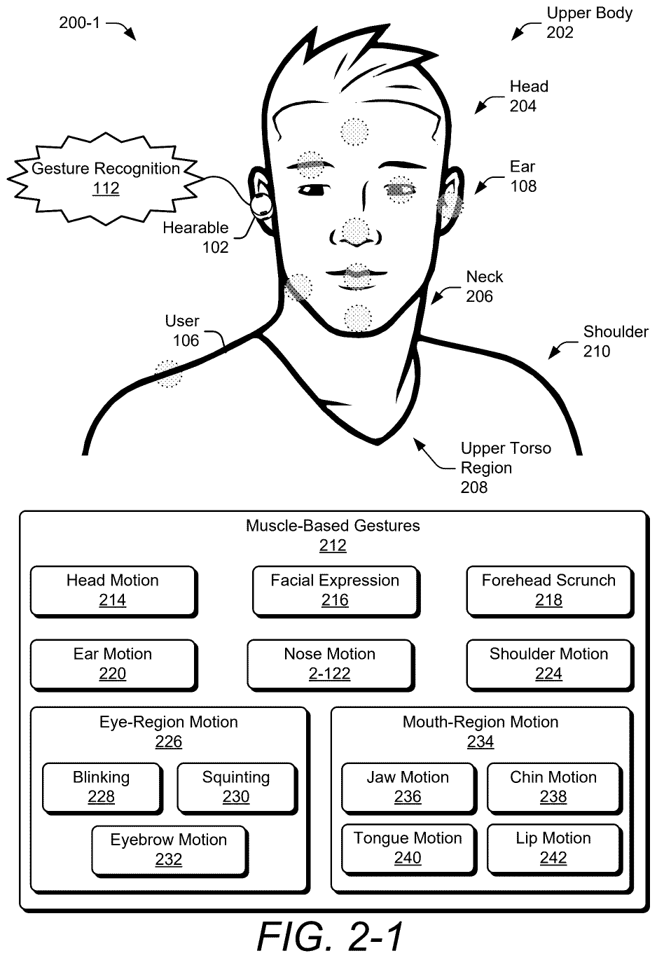

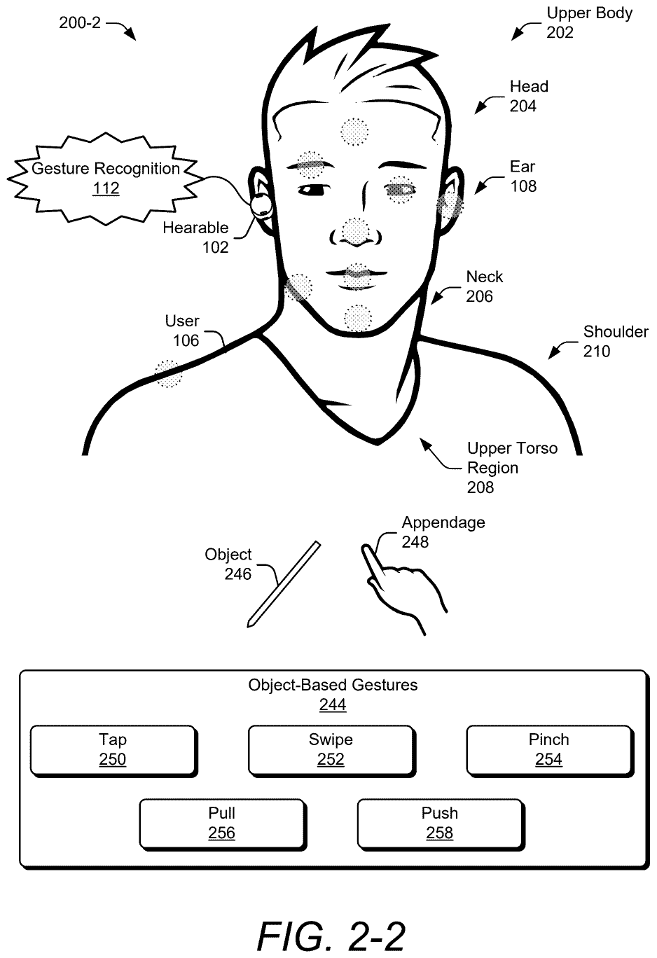

Gesture recognition 112 enables the hearable 102 to recognize gestures that involve the user 106 engaging different muscles to move different parts of their upper body and/or using an object (e.g., a stylus or an appendage) to interact with the one or more parts of their upper body, as further described with respect to FIGS. 2-1 and 2-2. With gesture recognition 112, a simple blink or tap on the cheek can be detected by the hearable 102 and used to control the hearable 102 and/or the computing device 104. More specifically, audioplethysmography 110 can detect subtle pressure waves that originate on the user 106's upper body and propagate to the user 106's ear canal 114. These pressure waves modify characteristics of acoustic signals that are transmitted and received by the hearable 102 and propagate through the ear canal 114.

With gesture recognition 112, the hearable 102 can support a larger quantity and a larger variety of controls compared to the limited touch-based controls of some hearables. This is because the user 106 can utilize an entire region of their upper body to perform different gestures whereas the touch-based controls are limited to the surface of other hearables. Furthermore, the muscle-based gestures enable the user 106 to control a device without using their hands. This provides the user 106 additional freedom as they can control the device while performing other activities with minimal interruption.

The controls provided by gesture recognition 112 can also enhance accessibility to people with disabilities and/or physical restrictions. Quadriplegics, for instance, can perform muscle-based gestures to interact with the hearable 102 and/or the computing device 104. In some cases, the gestures can be a faster and more intuitive way of controlling a device compared to other techniques, such as eye tracking.

The gestures can also provide a more socially acceptable means of controlling a device compared to voice-based controls. The unobtrusive nature of gestures can enable the user to control a device in a variety of quiet settings, including in a library or in a classroom. In addition to being discreet, gestures can be easy to detect and recognize in a loud environment compared to voice commands.

To use audioplethysmography 110, the user 106 positions the hearable 102 in a manner that creates at least a partial seal 116 around or in the ear 108. Some parts of the ear 108 are shown in FIG. 1-1, including the ear canal 114 and an ear drum 118 (or tympanic membrane). Due to the seal 116, the hearable 102, the ear canal 114, and the ear drum 118 couple together to form an acoustic circuit. Audioplethysmography 110 involves, at least in part, measuring properties associated with this acoustic circuit. The properties of the acoustic circuit can change due to a variety of different situations or actions.

For example, consider FIG. 1-2 in which a change occurs in a physical structure of the ear 108. Example changes to the physical structure include a change in a geometric shape of the ear canal 114 and/or a change in a volume of the ear canal 114. This change can be caused, at least in part, by subtle blood vessel deformations in the ear canal 114 caused by the user 106's heart pumping. Other changes can also can be caused by movement in the ear drum 118 or the movement of one or more parts of the user 106's upper body.

At 120, for instance, the tissue around the ear canal 114 and the ear drum 118 itself are slightly “squeezed” due to blood vessel deformation or a pressure wave. This squeeze causes a volume of the ear canal 114 to be slightly reduced at 120. At 122, however, the squeezing subsides and the volume of the ear canal 114 is slightly increased relative to 120. The physical changes within the ear 108 can modulate an amplitude and/or phase of an acoustic signal that propagates through the ear canal 114, as further described below.

During audioplethysmography 110, an acoustic signal propagates through at least a portion of the ear canal 114. The hearable 102 can receive an acoustic signal that represents a superposition of multiple acoustic signals that propagate along different paths within the ear canal 114. Each path is associated with a delay (i) and an amplitude (a). The delay and amplitude can vary over time due to the subtle changes that occur in the volume of the ear canal 114. The received acoustic signal can be represented by Equation 1:

$$S ( t ) = n + {\sum }_{i = 1}^{N - 1} {a}_{i} ( t ) cos ( {φ}_{ini} + {Ω}_{fc} ( t + {τ}_{i} ( t ) ) ) \qquad Equation 1$$

where S(t) represents the received acoustic signal, n represents noise, φᵢₙᵢ represents a relative phase between the received acoustic signal and the transmitted acoustic signal, Ω_{fc} represents a frequency of the transmitted acoustic signal, and t represents a time vector. Cardiac activities of the user 106, for instance, can modulate the amplitude and/or phase of the receive acoustic signal, as further shown in Equation 2:

$$S ( t ) = n + ( 1 + {h}_{amp} ( t ) ) cos ( {h}_{phase} ( t ) + {φ}_{ini} ++ {Ω}_{fc} ( t ) ) \qquad Equation 2$$

where hₐₘₚ(t) represents an amplitude modulator and hₚₕₐₛₑ(t) represents a phase modulator. The interactions between the hearable 102 and the ear 108 as well as the physiological activities of the user 106 modulate the amplitude and phase of the received acoustic signal.

The techniques for audioplethysmography 110 can be performed while the hearable 102 is playing audible content to the user 106 and/or while the user 106 is actively moving or performing an activity. As such, active acoustic sensing enables the hearable 102 to perform gesture recognition 112 in a variety of different situations. Example gestures that can be recognized using gesture recognition 112 are further described with respect to FIGS. 2-1 and 2-2.

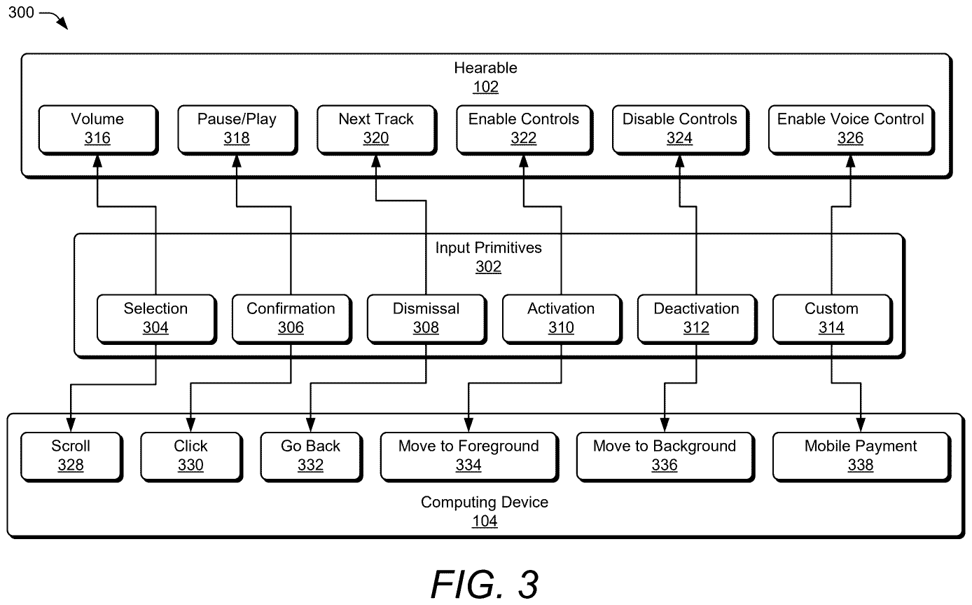

FIG. 2-1 illustrates an example environment 200-1 for performing aspects of gesture recognition 112 using active acoustic sensing. With gesture recognition 112, the user 106 can control an operation of the hearable 102 and/or an operation of the computing device 104 through audioplethysmography 110. Some gestures can be mapped to navigational inputs, such as advancing a playlist on the computing device 104, moving a cursor on the computing device 104, navigating a list of cards, dismissing an item on the computing device 104, or some combination thereof. Other gestures can be mapped to “take action” intents, such as initiating a timer on the computing device 104, silencing an alarm on the computing device 104, opening a notification or an application on the computing device 104, answering a phone call, starting or pausing the rendering of audio content by the hearable 102, activating one or more sensors on the hearable 102 or the computing device 104, or some combination thereof. In general, gesture recognition 112 enables touch-free and/or voice-free control of the hearable 102 and/or the computing device 104. Example controls are further described with respect to FIG. 3.

In the environment 200-1, an upper body 202 of the user 106 is shown to include a head 204, a neck 206, and an upper torso region 208. The upper torso region 208 can include the user 106's shoulders 210, collarbone region, and chest. In general, the upper torso region 208 is not considered to include the user 106's arms. To perform a muscle-based gesture 212, the user 106 engages muscles to move one or more parts of their upper body 202. Example parts of the upper body 202 are indicated by shaded circles in FIG. 2-1 and include the user 106's forehead, eyebrows, eyes, ears 108, nose, mouth, jaw, chin, neck 206, and shoulders 210.

With audioplethysmography 110, the hearable 102 can detect any muscle-based gesture 212 that creates a pressure wave that propagates to the ear canal 114. As the pressure wave interacts with the ear canal 114, the physical structure of the ear canal 114 can change (e.g., a volume of the ear canal 114 can change). The hearable 102 can detect the change in the physical structure of the ear canal 114 to recognize one or more muscle-based gestures 212. Depending on the sensitivity of the hearable 102, the hearable 102 can detect pressure waves that originate on the head 204, the neck 206, the upper torso region 208, or on other regions of the body. In general, different muscle-based gestures 212 can be associated with different durations, frequencies, intensities, and/or origins of the pressure wave.

A first type of muscle-based gesture 212 includes movement of the head 204, which is referred to as head motion 214. Various gestures associated with the head motion 214 can involve the user 106 moving their head from one side to another (e.g., from left to right or from right to left), moving their head up and down, or shaking their head in a back and forth motion.

A second type of muscle-based gesture 212 includes a facial expression 216. Example facial expressions 216 can include smiling, frowning, or scowling. The facial expressions 216 enable gesture recognition 112 to provide information regarding an emotional state of the user 106. This information can provide additional context for other data collected using audioplethysmography 110, such as biometrics of the user 106. It can also be used for mood-tracking applications or for evaluating the effectiveness of some activities, such as meditation, for improving the user 106's overall mood. As another example, the facial expressions 216 can be used by the computing device 104 for suggesting mood-appropriate audible content to the user 106.

A third and fourth type of muscle-based gesture 212 includes a forehead scrunch 218 and ear motion 220. The forehead scrunch 218 can be associated with a facial expression 216 (e.g., scowling) or recognized as its own distinct muscle-based gesture 212. Various gestures associated with the ear motion 220 can involve the user 106 moving their left ear 108, moving their right ear 108, or moving both ears 108 at the same time.

A fifth and sixth type of muscle-based gesture 212 includes nose motion 222 and shoulder motion 224. The nose motion 222 can involve the user 106 flaring their nostrils and/or wiggling their nose from side to side. The shoulder motion 224 can involve the user 106 rolling one or both of their shoulders 210 or shrugging their shoulders 210. Additionally or alternatively, rolling a shoulder 210 forward can represent one type of gesture while rolling a shoulder 210 backwards can represent another type of gesture.

Gesture recognition 112 can also recognize various muscle-based gestures 212 associated with movement within the eye region. Example eye-region motions 226 can involve the user 106 blinking 228, squinting 230, or moving their eyebrows, which is represented by eyebrow motion 232. Various gestures associated with blinking 228 can include the user 106 blinking 228 with one eye (e.g., winking), blinking 228 with both eyes, blinking 228 once, or blinking 228 multiple times. Different blink-type gestures can be associated with different durations of blinking 228 (e.g., a slow blink or a fast blink) and/or different frequencies of blinking 228. Squinting 230 can include the user 106 squinting 230 a certain eye or squinting 230 with both eyes. The eyebrow motion 232 can involve the user 106 raising and/or lowering one or both eyebrows.

The hearable 102 can also recognize various muscle-based gestures 212 associated with the mouth region. Example mouth-region motions 234 can include jaw motion 236, chin motion 238, tongue motion 240, and/or lip motion 242. Various jaw motions 236 can involve the user 106 opening and/or closing their jaw, moving their jaw to one side, moving their jaw from side to side, moving their jaw forward and backwards, clenching their jaw, tapping their teeth, and/or yawning. The chin motion 238 can involve the user 106 thrusting their chin forward and/or moving it from side to side. In some cases, the jaw motion 236 and the chin motion 238 can be associated together with a single gesture. In other cases, the chin motion 238 can represent a muscle-based gesture 212 that is separate and distinct from the jaw motion 236. Various tongue motions 240 can include the user 106 flicking their tongue up and down, flicking their tongue side to side, clicking with their tongue, or forming their tongue into a shape. A tongue flick can involve the user 106 positioning their tongue to touch the roof of their mouth or the top of their teeth and rapidly moving the tongue down. Example lip motions 242 can include the user 106 opening their mouth or closing their mouth.

Other types of muscle-based gestures 212 not shown in FIG. 2-1 can include twitching a cheek to the left or right, flexing a pectoral muscle, swallowing, and so forth. In some cases, the muscle-based gestures 212 that the hearable 102 can recognize are associated with parts of the upper body 202 that are less likely to be activated unintentionally by the user 106. In some implementations, the hearable 102 can detect and recognize non-gesture-type motions, such as face scratching or chewing food, in order to reduce false positives.

Some muscle-based gestures 212 can be defined by a combination of movements or conditions. For example, a first muscle-based gesture 212 can involve a jaw motion 236 while the user 106's mouth is opened and a second muscle-based gesture 212 can involve the same jaw motion 236 while the user 106's mouth is closed. A same tongue motion 240 can also correspond to different muscle-based gestures 212 depending on whether the user 106's mouth is open or closed. The hearable 102 can also use gesture recognition 112 to detect object-based gestures, as further described with respect to FIG. 2-2.

FIG. 2-2 illustrates another example environment 200-2 for performing aspects of gesture recognition 112 using active acoustic sensing. With audioplethysmography 110, the hearable 102 can detect any object-based gesture 244 that creates a pressure wave that propagates to the ear canal 114. As the pressure wave interacts with the ear canal 114, the physical structure of the ear canal 114 can change (e.g., a volume of the ear canal 114 can change). The hearable 102 can detect the change in the physical structure of the ear canal 114 to recognize one or more object-based gestures 244. Depending on the sensitivity of the hearable 102, the hearable 102 can detect pressure waves that originate on the head 204, the neck 206, the upper torso region 208, or on other regions of the body.

For object-based gestures 244, the user 106 performs an action (or motion) by touching an object 246 (e.g., a pen, a stylus, or a ring) or an appendage 248 (e.g., a finger, a hand, or an arm) or to one or more parts of the upper body 202. Example actions or motions include a tap 250, a swipe 252, a pinch 254, a pull 256 (or tug), a push 258 (or application of pressure), or some combination thereof. The user 106, for instance, can use one or more fingers to tap 250 an external part of their ear 108 (e.g., the pinna), to tap 250 their nose, or to tap their shoulder 210. In this case, different tap-based gestures can be associated with different parts of the upper body 202 as well as the quantity of the taps 230, the frequency of the taps 230, and/or the strength of the tap 250 (e.g., a hard tap, a soft tap, a tap using one finger, or a tap using multiple fingers).

As another example, the user 106 can swipe 252 a pen across their cheek or brush their fingers through their hair. Different swipe-based gestures can be associated with different parts of the upper body 202 as well as different directions in which the swipe 252 is performed. The user 106 can also pull 256 their ear lobe or can rest their chin on their hand, which effectively pushes 238 their chin. As another option, the user 106 can pinch 254 their neck 206. Different gestures can be associated with different parts of the upper body 202 that are pulled 236, pushed 238, or pinched 234. In general, different object-based gestures 244 can be associated with different durations, frequencies, intensities, and/or origins of the pressure wave. Some object-based gestures 244 can be two-dimensional, such as those used with touch-sensitive displays (e.g., a two-finger pinch or a two-finger spread).

A muscle-based gesture 212 or an object-based gesture 244 can represent a discrete, single movement that occurs once. An example discrete jaw motion 236 can involve the user 106 moving their jaw in one direction (e.g., left or right) and then returning their jaw to a center position. An example discrete tap 250 gesture can involve the user 106 tapping their cheek once. Additionally or alternatively, a muscle-based gesture 212 and/or an object-based gesture 244 can represent a continuous movement or a movement that is held over a predetermined time interval. An example continuous jaw motion 236 can involve the user 106 moving their jaw in one direction (e.g., left or right), holding that position for a predetermined amount of time, and then returning their jaw to a center position. Another example continuous jaw motion 236 can involve the user 106 wiggling their jaw back and forth repeatedly for a predetermined amount of time. An example continuous tap 250 can involve the user 106 using an object 246 or an appendage 248 to tap their cheek multiple times in a continuous manner.

Muscle-based gestures 212 and object-based gestures 244 can be more discreet compared to gestures made in the air, especially in a social setting. Muscle-based gestures 212 can differ from object-based gestures 244 in that muscle-based gestures 212 allow for hands-free input, which can be convenient when the user 106 is using their hands to perform another task. Muscle-based gestures 212, however, can be more challenging to detect compared to the object-based gestures 244, especially without the use of audioplethysmography 110.

In some implementations, the hearable 102 is pre-programmed to recognize one or more muscle-based gestures 212 and/or object-based gestures 244. Additionally or alternatively, the hearable 102 can be trained to recognize muscle-based gestures 212 and/or object-based gestures 244 defined by the user 106. The user 106 can use the hearable 102 or the computing device 104 to link specific controls with each recognizable muscle-based gesture 212. Example controls are further described with respect to FIG. 3.

FIG. 3 illustrates an example mapping 300 of input primitives 302 to various controls. Input primitives 302 represent basic actions a user 106 can take to interact with a device. Each input primitive 302 can mapped to a controllable operation of the hearable 102, which is shown at the top of FIG. 3, and/or a controllable operation of the computing device 104, which is shown at the bottom of FIG. 3. Example input primitives 302 include selection 304, confirmation 306, dismissal 308, activation 310, deactivation 312, custom 314 (or custom mapping), and so forth.

In general, the controllable features of the hearable 102 can include those that impact the presentation of audio content to the user 106. Example controllable operations of the hearable 102 include controlling a volume 316 of the hearable 102, pausing or playing 318 audio content, advancing audio content to a next track 320 (e.g., a next song), enabling gesture controls 322 (enable controls 322), disabling gesture controls 324 (disable controls 324), and/or enabling voice control 326.

The controllable features of the computing device 104 can include those that enable the user 106 to navigate a screen. Example controllable operations of the computing device 104 for navigation can include scrolling 328, clicking 330, going back 332, moving an object to a foreground 334, or moving an object to a background 336. The computing device 104 can also include customizable controls or shortcuts, such as making a mobile payment 338. Other controllable operations of the computing device 104 can include configuring the computing device 104 with a particular setting (e.g., silent mode or airplane mode), controlling a component (e.g., a camera or a sensor) of the computing device 104, controlling a volume of the computing device 104, silencing a phone call, and/or interacting with a particular application executing on the computing device 104 (e.g., controlling buttons for a mobile game or activating a shortcut to open a specific application).

In this example, each input primitive 302 is mapped to a control of the hearable 102 and a navigation control of the computing device 104. Other examples are also possible in which an input primitive 302 is mapped to a control of the hearable 102 or a control of the computing device 104. Although not explicitly shown in FIG. 3, each input primitive 302 can also be mapped to one or more muscle-based gestures 212 and/or object-based gestures 244.

In some cases, a same gesture (e.g., a same muscle-based gesture 212 or a same object-based gesture 244) can be mapped to controlling an operation of the hearable 102 and controlling an operation of the computing device 104. A determination of which entity is controlled can be based on a setting of the hearable 102 and/or the computing device 104. As an example, the gesture can be mapped to a control the hearable 102 if the enable controls 322 setting is engaged. Otherwise, the gesture can be mapped to a control the computing device 104 if the disable controls 324 setting is engaged.

In other cases, different gestures 212 (e.g., different muscle-based gestures 212, different object-based gestures 244, or some combination thereof) can be mapped to controlling the operation of different devices. For example, a gesture can be used to control an operation of the hearable 102 and a second gesture can be used to control an operation of the computing device 104. The first and second gestures can be associated with a same input primitive 302 or different input primitives 302.

In FIG. 3, the selection 304 input primitive 302 is mapped to the volume 316 control of the hearable 102 and a scroll 328 control of the computing device 104. In an example implementation, the jaw motion 236 can be used to activate the selection 304 input primitive 302. A direction in which the user 106's jaw moves can adjust the volume 316 in different manners and adjust the direction of the scrolling 328 in different manners. For example, moving the jaw to the left can cause the volume 316 to decrease or can cause the computing device 104 to scroll 328 in a first direction (e.g., down and/or left). In contrast, moving the jaw to the right can cause the volume 316 to increase or can cause the computing device 104 to scroll 328 in a second direction that is opposite the first direction (e.g., up and/or right).

The confirmation 306 input primitive 302 is mapped to pausing or playing 318 the presentation of audible content by the hearable 102 and a click 330 control of the computing device 104. In an example implementation, a tongue motion 240, such as a tongue flick, can activate the click 330 control of the computing device 104. Also, a jaw motion 236, such as clenching of the jaw, can activate the pause/play 318 control of the hearable 102. In this example, different muscle-based gestures 212 are mapped to the same input primitive 302, but are associated with different devices (e.g., the hearable 102 or the computing device 104). In another example implementation, a push 258 can activate the click 330 control of the computing device 104 or the pause/play 318 control of the hearable 102. In this example, the input primitive 302 can be used to control different devices in different manners.

Additionally, the dismissal 308 input primitive 302 is mapped to the next track 320 control of the hearable 102 and the go back 332 control of the computing device 104. In an example implementation, a tongue motion 240, such as a double tongue flick, can activate the go back 332 control of the computing device 104. Also, another tongue motion 240 or another jaw motion 236 can activate the next track 320 control of the hearable 102. For instance, the other tongue motion 240 can include a single tongue flick or the other jaw motion 236 can be a continuous jaw motion 236 that involves moving the jaw to the right and holding that position for a predetermined amount of time. In another example implementation, a tap 250, such as a double tap, can activate the go back 332 control of the computing device 104 while a swipe 252 can activate the next track 320 control of the hearable 102.

The activation 310 input primitive 302 is mapped to the enable controls 322 of the hearable and the move to foreground 334 control of the computing device 104. The deactivation 312 input primitive 302 is mapped to the disable controls 324 of the hearable 102 and the move to background 336 control of the computing device 104. The custom 314 input primitive 302 is mapped to the enable voice control 326 of the hearable 102 and the mobile payment 338 of the computing device 104. Various muscle-based gestures 212 and/or object-based gestures 244 can activate these input primitives 302. In general, each input primitive 302 is associated with a different gesture. In some cases, an input primitive 302 is associated with more than one gesture to enable discrete control of different entities (e.g., control of the hearable 102 and control of the computing device 104).

In some implementations, the user 106 can specify and/or customize the mapping 300 between the input primitives 302 and the controllable operations of the hearable 102 and/or the computing device 104. Additionally or alternatively, a default mapping and/or a non-configurable mapping can be provided.

In addition to supporting a touch-free and voice-free user interface, gesture recognition 112 can be used for other use cases, including monitoring the user 106's health. For example, by monitoring the facial expressions 216, gesture recognition 112 can be used to determine the user 106's mood and/or stress level. Gesture recognition 112 can also be used to enhance accessibility. For example, by recognizing that the user 106 is squinting 230, the computing device 104 can increase a font size to reduce eye strain. The computing device 104 is further described with respect to FIG. 4.

FIG. 4 illustrates an example implementation of the computing device 104. The computing device 104 is illustrated with various non-limiting example devices including a desktop computer 104-1, a tablet 104-2, a laptop 104-3, a television 104-4, a computing watch 104-5, computing glasses 104-6, a gaming system 104-7, a microwave 104-8, and a vehicle 104-9. Other devices may also be used, such as an augmented and/or virtual reality headset, a home service device, a smart speaker, a smart thermostat, a baby monitor, a Wi-Fi™ router, a drone, a trackpad, a drawing pad, a netbook, an e-reader, a home automation and control system, a wall display, and another home appliance. Note that the computing device 104 can be wearable, non-wearable but mobile, or relatively immobile (e.g., desktops and appliances).

The computing device 104 includes one or more computer processors 402 and at least one computer-readable medium 404, which includes memory media and storage media. Applications and/or an operating system (not shown) embodied as computer-readable instructions on the computer-readable medium 404 can be executed by the computer processor 402 to provide some of the functionalities described herein. The computer-readable medium 404 also includes an application 406. Some applications 406 can uses information provided by the hearable 102 to perform an action. Example actions can include displaying data associated with audioplethysmography 110 to the user 106.

The computer-readable medium 404 can optionally include a gesture-based control module 408. The gesture-based control module 408 controls an operation of the computing device 104 based on the gestures recognized using audioplethysmography 110. Example operations can include the controls described with respect to FIG. 3 and/or controlling one or more aspects of the application 406.

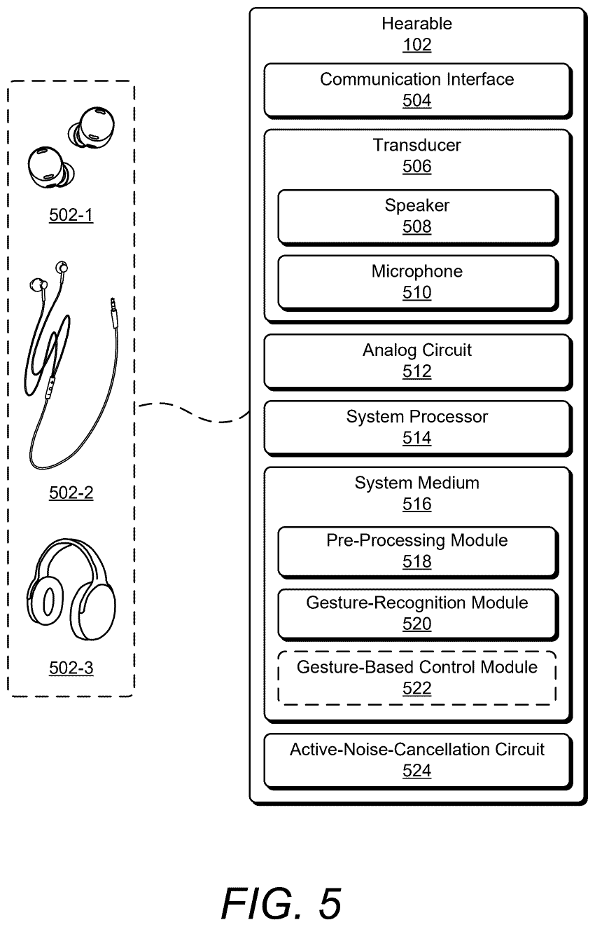

The computing device 104 can also include a network interface 410 for communicating data over wired, wireless, or optical networks. For example, the network interface 410 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, Bluetooth®, and the like. The computing device 104 may also include the display 412. Although not explicitly shown, the hearable 102 can be integrated within the computing device 104, or can connect physically or wirelessly to the computing device 104. The hearable 102 is further described with respect to FIG. 5.

FIG. 5 illustrates an example hearable 102. The hearable 102 is illustrated with various non-limiting example devices, including wireless earbuds 502-1, wired earbuds 502-2, and headphones 502-3. The earbuds 502-1 and 502-2 are a type of in-ear device that fits into the ear canal 114. Each earbud 502-1 or 502-2 can represent a hearable 102. Headphones 502-3 can rest on top of or over the ears 108. The headphones 502-3 can represent closed-back headphones, open-back headphones, on-ear headphones, or over-ear headphones. Each headphone 502-2 includes two hearables 102, which are physically packaged together. In general, there is one hearable 102 for each ear 108.

The hearable 102 includes a communication interface 504 to communicate with the computing device 104, though this need not be used when the hearable 102 is integrated within the computing device 104. The communication interface 504 can be a wired interface or a wireless interface, in which audio content is passed from the computing device 104 to the hearable 102. The hearable 102 can also use the communication interface 504 to pass data associated with audioplethysmography 110 to the computing device 104. In general, the data provided by the communication interface 504 is in a format usable by the application 406 and/or the gesture-based control module 408.

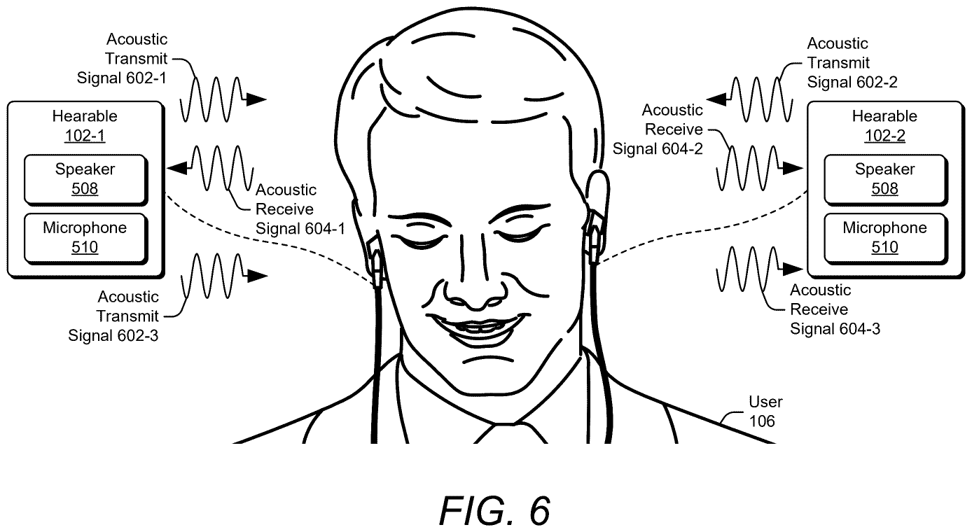

The communication interface 504 also enables the hearable 102 to communicate with another hearable 102. During bistatic sensing, for instance, the hearable 102 can use the communication interface 504 to coordinate with the other hearable 102 to support two-ear audioplethysmography 110, as further described with respect to FIG. 6. In particular, the transmitting hearable 102 can communicate timing and waveform information to the receiving hearable 102 to enable the receiving hearable 102 to appropriately demodulate a received acoustic signal.

The hearable 102 includes at least one transducer 506 that can convert electrical signals into sound waves. The transducer 506 can also detect and convert sound waves into electrical signals. These sound waves may include ultrasonic frequencies and/or audible frequencies, either of which may be used for audioplethysmography 110. In particular, a frequency spectrum (e.g., range of frequencies) that the transducer 506 uses to generate an acoustic signal can include frequencies from a low-end of the audible range to ahigh-end of the ultrasonic range, e.g., between 20 hertz (Hz) to 2 megahertz (MHz). Other example frequency spectrums for audioplethysmography 110 can encompass frequencies between 20 Hz and 20 kilohertz (kHz), between 20 kHz and 2 MHz, between 20 and 60 kHz, between 20 Hz and 96 kHz, or between 30 and 40 kHz.

In an example implementation, the transducer 506 has a monostatic topology. With this topology, the transducer 506 can convert the electrical signals into sound waves and convert sound waves into electrical signals (e.g., can transmit or receive acoustic signals). Example monostatic transducers may include piezoelectric transducers, capacitive transducers, and micro-machined ultrasonic transducers (MUTs) that use microelectromechanical systems (MEMS) technology.

Alternatively, the transducer 506 can be implemented with a bistatic topology, which includes multiple transducers that are physically separate. In this case, a first transducer converts the electrical signal into sound waves (e.g., transmits acoustic signals), and a second transducer converts sound waves into an electrical signal (e.g., receives the acoustic signals). An example bistatic topology can be implemented using at least one speaker 508 and at least one microphone 510. The speaker 508 and the microphone 510 can be dedicated for audioplethysmography 110 or can be used for both audioplethysmography 110 and other functions of the computing device 104 (e.g., presenting audible content to the user 106, capturing the user 106's voice for a phone call, or for voice control).

In general, the speaker 508 and the microphone 510 are directed towards the ear canal 114 (e.g., oriented towards the ear canal 114). Accordingly, the speaker 508 can direct acoustic signals towards the ear canal 114, and the microphone 510 is responsive to receiving acoustic signals from the direction associated with the ear canal 114.

The hearable 102 includes at least one analog circuit 512, which includes circuitry and logic for conditioning electrical signals in an analog domain. The analog circuit 512 can include analog-to-digital converters, digital-to-analog converters, amplifiers, filters, mixers, and switches for generating and modifying electrical signals. In some implementations, the analog circuit 512 includes other hardware circuitry associated with the speaker 508 or microphone 510.

The hearable 102 also includes at least one system processor 514 and at least one system medium 516 (e.g., one or more computer-readable storage media). In the depicted configuration, the system medium 516 includes a pre-processing module 518 and a gesture-recognition module 520. The system medium 516 also optionally includes a gesture-based control module 522. The pre-processing module 518, the gesture-recognition module 520, and the gesture-based control module 522 can be implemented using hardware, software, firmware, or a combination thereof. In this example, the system processor 514 implements the pre-processing module 518, the gesture-recognition module 520, and the gesture-based control module 522. In an alternative example, the computer processor 402 of the computing device 104 can implement at least a portion of the pre-processing module 518, the gesture-recognition module 520, and the gesture-based control module 522. In this case, the hearable 102 can communicate digital samples of the acoustic signals to the computing device 104 using the communication interface 504.

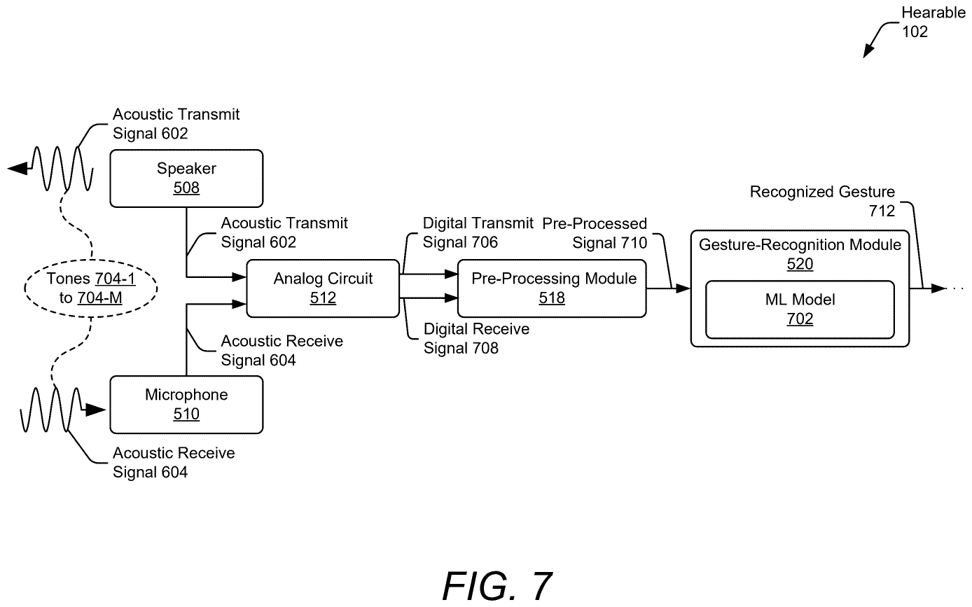

Operations of the pre-processing module 518, the gesture-recognition module 520, and the gesture-based control module 522 are further described with respect to FIGS. 7 to 10. Aspects of gesture recognition 112 using active acoustic sensing can be performed, at least partially, by the gesture-recognition module 520, as further described with respect to FIG. 7. The gesture-based control module 522 controls an operation of the hearable 102 based on the gestures recognized using audioplethysmography 110. Example operations can include the controls described with respect to FIG. 3.

Some hearables 102 include an active-noise-cancellation circuit 524, which enables the hearables 102 to reduce background or environmental noise. In this case, the microphone 510 used for audioplethysmography 110 can be implemented using a feedback microphone of the active-noise-cancellation circuit 524. During active noise cancellation, the feedback microphone provides feedback information regarding the performance of the active noise cancellation. During audioplethysmography 110, the feedback microphone receives an acoustic signal, which is provided to the pre-processing module 518. In some situations, active noise cancellation and audioplethysmography 110 are performed simultaneously using the feedback microphone. In this case, the acoustic signal received by the feedback microphone can be provided to the pre-processing module 518 and the active-noise-cancellation circuit 524.

Although not explicitly shown, the hearable 102 can also include at least one motion sensor. Example motion sensors include an inertial measurement unit (IMU), an accelerometer, an inclinometer, a gyroscope, a magnetometer, or some combination thereof. In general, the motion sensor provides motion data to the gesture-recognition module 520 to further improve performance of gesture recognition 112. In particular, enhancing audioplethysmography 110 with data from other sensor modalities (e.g., motion data from a motion sensor or audio signals from the microphone 510) can improve detectability and reduce false positives. Different types of audioplethysmography 110 are further described with respect to FIG. 6.

### Audioplethysmography

FIG. 6 illustrates example operations of two hearables 102-1 and 102-2. In a first example operation, the hearables 102-1 and 102-2 perform single-ear audioplethysmography 110. This means that the hearables 102-1 and 102-2 independently perform audioplethysmography 110 on different ears 108 of the user 106. In this case, the first hearable 102-1 is proximate to the user 106's right ear 108, and the second hearable 102-2 is proximate to the user 106's left ear 108. Each hearable 102-1 and 102-2 includes a speaker 508 and a microphone 510. The hearables 102-1 and 102-2 can operate in a monostatic manner during the same time period or during different time periods. In other words, each hearable 102-1 and 102-2 can independently transmit and receive acoustic signals.

For example, the first hearable 102-1 uses the speaker 508 to transmit a first acoustic transmit 602-1, which propagates within at least a portion of the user 106's right ear canal 114. The first hearable 102-1 uses the microphone 510 to receive a first acoustic receive signal 604-1. The first acoustic receive signal 604-1 represents a version of the first acoustic transmit signal 602-1 that is modified, at least in part, by the acoustic circuit associated with the right ear canal 114. This modification can change an amplitude, phase, and/or frequency of the first acoustic receive signal 604-1 relative to the first acoustic transmit signal 602-1.

Similarly, the second hearable 102-2 uses the speaker 508 to transmit a second acoustic transmit signal 602-2, which propagates within at least a portion of the user 106's left ear canal 114. The second hearable 102-2 uses the microphone 510 to receive a second acoustic receive signal 604-2. The second acoustic receive signal 604-2 represents a version of the second acoustic transmit signal 602-2 that is modified by the acoustic circuit associated with the left ear canal 114. This modification can change an amplitude, phase, and/or frequency of the second acoustic receive signal 604-2 relative to the second acoustic transmit signal 602-2.

The techniques of single-ear audioplethysmography 110 can be particularly beneficial as it enables the computing device 104 to compile information from both hearables 102-1 and 102-2, which can further improve measurement confidence. For some aspects of audioplethysmography 110, it can be beneficial to analyze the acoustic channel between two ears 108, as further described below.

In a second example operation, the two hearables 102-1 and 102-2 perform two-ear audioplethysmography 110. This means that the hearables 102-1 and 102-2 jointly perform audioplethysmography 110 across two ears 108 of the user 106. In this case, at least one of the hearables 102 (e.g., the first hearable 102-1) includes the speaker 508, and at least one of the other hearables 102 (e.g., the second hearable 102-2) includes the microphone 510. The hearables 102-1 and 102-2 operate together in a bistatic manner during the same time period.

During operation, the first hearable 102-1 transmits a third acoustic transmit 402-3 using the speaker 508. The third acoustic transmit signal 602-3 propagates through the user 106's right ear canal 114. The third acoustic transmit signal 602-3 also propagates through an acoustic channel that exists between the right and left ears 108. In the left ear 108, the third acoustic transmit signal 602-3 propagates through the user 106's left ear canal 114 and is represented as a third acoustic receive signal 604-3. The second hearable 102-2 receives the third acoustic receive signal 604-3 using the microphone 510. The third acoustic receive signal 604-3 represents a version of the third acoustic transmit signal 602-3 that is modified by the acoustic circuit associated with the right ear canal 114, modified by the acoustic channel associated with the user 106's face, and modified by the acoustic circuit associated with the left ear canal 114. This modification can change an amplitude, phase, and/or frequency of the third acoustic receive signal 604-3 relative to the third acoustic transmit signal 602-3. In some cases, the hearable 102-2 measures the time-of-flight (ToF) associated with the propagation from the first hearable 102-1 to the second hearable 102-2. Sometimes a combination of single-ear and two-ear audioplethysmography 110 are applied to further improve measurement confidence.

The acoustic transmit signals 602 of FIG. 6 can represent a variety of different types of signals. As described above with respect to FIG. 5, the acoustic transmit signal 602 can be an ultrasonic signal and/or an audible signal. Also, the acoustic transmit signal 602 can be a continuous-wave signal (e.g., a sinusoidal signal) or a pulsed signal. Some acoustic transmit signals 602 can have a particular tone (or frequency). Other acoustic transmit signals 602 can have multiple tones (or multiple frequencies). A variety of modulations can be applied to generate the acoustic transmit signal 602. Example modulations include linear frequency modulations, triangular frequency modulations, stepped frequency modulations, phase modulations, or amplitude modulations. The acoustic transmit signal 602 can be transmitted to support gesture recognition 112, as further described as part of FIG. 7.

### Gesture Recognition

FIG. 7 illustrates an example implementation of the hearable 102 for performing gesture recognition 112 using active acoustic sensing. In the depicted configuration, the hearable 102 includes the speaker 508, the microphone 510, the analog circuit 512, the pre-processing module 518, and the gesture-recognition module 520. Although not explicitly shown in FIG. 7, the hearable 102 can optionally include the gesture-based control module 522.

Outputs of the speaker 508 and the microphone 510 are coupled to inputs of the analog circuit 512. The pre-processing module 518 has inputs that are coupled to outputs of the analog circuit 512. The pre-processing module 518 also has an output that is coupled to an input of the gesture-recognition module 520. An output of the gesture-recognition module 520 can be coupled to the gesture-based control module 522 (not shown) and/or the communication interface 504 (not shown).

In this example, the gesture-recognition module 520 is implemented using a machine-learned model 702 (ML model 702). Other examples are also possible in which the gesture-recognition module 520 uses other signal processing and/or data analysis techniques. The machine-learned model 702 is implemented using one or more neural networks. A neural network includes a group of connected nodes (e.g., neurons or perceptrons), which are organized into one or more layers. As an example, the machine-learned model 702 includes a deep neural network, which includes an input layer, an output layer, and one or more hidden layers positioned between the input layer and the output layers. The nodes of the deep neural network can be partially-connected or fully-connected between the layers.

In some implementations, the neural network is a recurrent neural network (e.g., a long short-term memory (LSTM) neural network) with connections between nodes forming a cycle to retain information from a previous portion of an input data sequence for a subsequent portion of the input data sequence. In other cases, the neural network is a feed-forward neural network in which the connections between the nodes do not form a cycle. Additionally or alternatively, the machine-learned model 702 includes another type of neural network, such as a convolutional neural network. The machine-learned model 702 can also include one or more types of classification models, such as a binary classification model, a multi-class classification model, multi-label classification, and so forth. In general, the machine-learned model 702 is trained using supervised learning to identify at least one gesture (e.g., at least one muscle-based gesture 212 or at least one object-based gesture 244) based on a version of the acoustic receive signal 604, as further described below. In general, the supervised learning can use simulated (e.g., synthetic) data or measured (e.g., real) data for training purposes.

Consider an example operation of the hearable 102 in accordance with single-ear audioplethysmography 110. The speaker 508 transmits the acoustic transmit signal 602, and the microphone 510 receives the acoustic receive signal 604. The acoustic transmit signal 602 and the acoustic receive signal 604 can have tones 704-1 to 704-M, where M represents a positive integer. Each tone 704 represents a carrier frequency. The tones 704 can be transmitted in parallel or in series over a given time interval.

An amplitude of the acoustic transmit signal 602 can be approximately the same across the tones 704-1 to 704-M. In this manner, power is evenly distributed across each tone 704. Transmitting the tones 704 using higher amplitudes and/or the longer durations can further improve the signal-to-noise ratio performance of the hearable 102 for gesture recognition 112.

A single continuous acoustic transmit signal 602 or multiple discrete acoustic transmit signals 602 can be transmitted overtime to enable various gestures to be recognized. In general, the acoustic transmit signal 602 (or the multiple acoustic transmit signals 602) can be transmitted in a manner that is sufficient for detecting a fastest and/or smallest gesture. This can include adjusting the transmission repetition frequency in the case that multiple discrete acoustic transmit signals 602 are transmitted or adjusting the transmission power.

Consider that some gestures, such as the jaw motion 236 or a swipe 252, may take significantly more time to perform compared to other gestures, such as a tongue motion 240 or a tap 250. As such a relatively low transmission repetition frequency can be used for transmitting the multiple discrete acoustic transmit signals 602 if the jaw motion 236 or swipe 252 is mapped to an input primitive 302 and the tongue motion 240 or tap 250 is not mapped to an input primitive 302. A slower transmission repetition frequency can help conserve power. Alternatively, a relatively higher transmission repetition frequency can be used if the tongue motion 240 or tap 250 is mapped to an input primitive 302.

Also consider that gestures can occur further away from the ear 108 or involve smaller intensities. If these gestures can be used to activate an input primitive 302, the hearable 102 can increase sensitivity for detecting these gestures by increasing the transmission power. Alternatively, if these gestures are not supported or mapped to an input primitive 302, the hearable 102 can use a lower transmission power to conserve power.

In an example implementation, the acoustic transmit signal 602 has eleven tones that are distributed between 30 and 35 kHz. In some cases, the tones 704 are evenly distributed across an interval. For example, the tones 704 can be in 500 Hz increments between 30 kHz and 35 kHz (e.g., at approximately 30.0, 30.5, 31.0, 31.5, 32.0, 32.5, 33.0, 33.5, 34.0, 34.5, and 35 kHz). The term “approximately” means that the tones 704 can be within 5% of a given value or less (e.g., within 3%, 2%, or 1% of the given value).

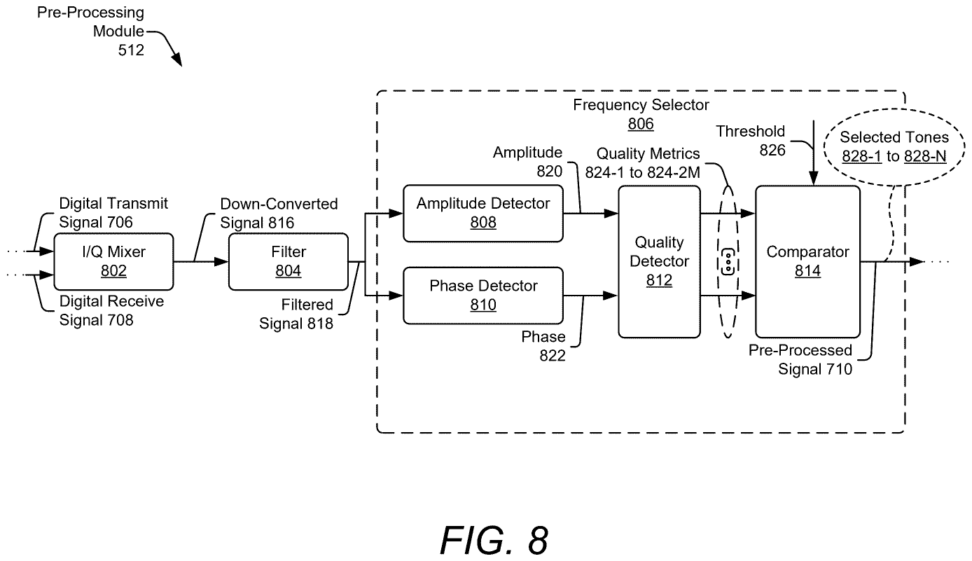

The analog circuit 512 performs analog-to-digital conversion to generate a digital transmit signal 706 and a digital receive signal 708 based on the acoustic transmit signal 602 and the acoustic receive signal 604, respectively. The pre-processing module 518 performs frequency downconversion and demodulation to generate a pre-processed signal 710 based on the digital transmit signal 706 and the digital receive signal 708. The pre-processing module 518 can also apply filtering to generate the pre-processed signal 710. An example implementation of the pre-processing module 518 is further described with respect to FIG. 8.

The gesture-recognition module 520 can perform aspects of gesture recognition 112 to recognize a gesture performed by the user 106. In particular, the machine-learned model 702 is trained to accept the pre-processed signal 710 as an input signal and output a recognized gesture 712, which indicates a gesture-based classification determined by the machine-learned model 702. Example pre-processed signals 710 associated with different gestures are further described with respect to FIGS. 11-1 to 16. In one aspect, the gesture-recognition module 520 can detect a significant change in amplitude and/or phase associated with one or more of the carrier frequencies of the acoustic receive signal 604 and appropriately associated this detection with one of the gestures to correctly generate the recognized gesture 712.

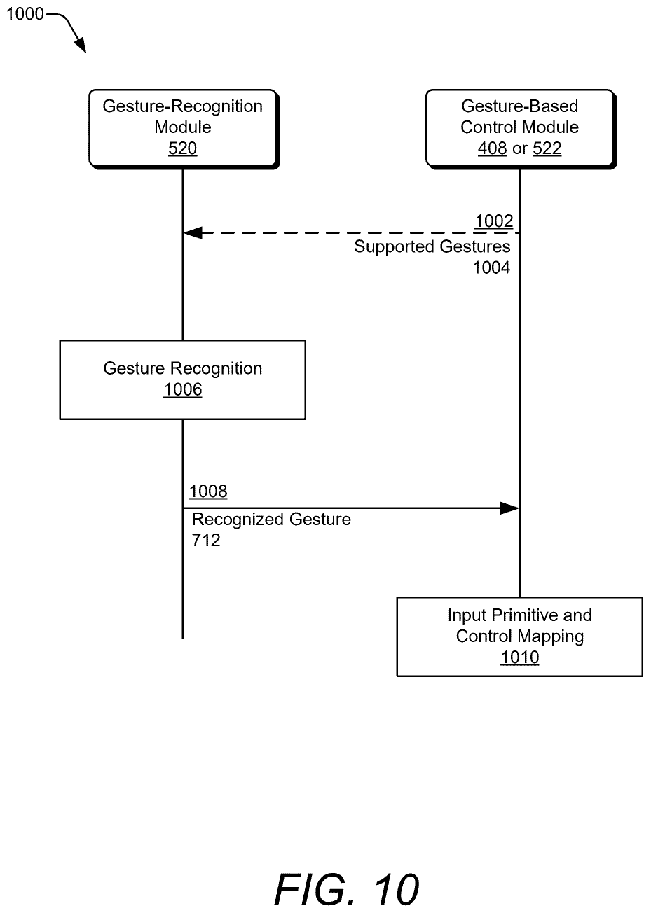

In some implementations, the machine-learned model 702 is trained to utilize data provided by other sensor modalities, such as data provided by a motion sensor or an audio signal provided by the microphone 510, in addition to the pre-processed signal 710 to generate the recognized gesture 712. The motion sensor data can be used to attenuate motion artifacts that can be observed within the pre-processed signal 710 while the user is moving. The motion sensor data and/or the audio signal can also be used to detect some types of gestures that make a noise, such as a tongue click. The recognized gesture 712 can be communicated to the gesture-based control module 522 of the hearable 102 or the gesture-based control module 408 of the computing device 104 as further described with respect to FIG. 10. An example implementation of the pre-processing module 518 is further described with respect to FIG. 8.

FIG. 8 illustrates an example implementation of the pre-processing module 518 for performing active acoustic sensing. In the depicted configuration, the pre-processing module 518 includes at least one in-phase and quadrature mixer 802 (I/Q mixer 1002) and at least one filter 804. The in-phase and quadrature mixer 802 performs frequency down-conversion. In an example implementation, the in-phase and quadrature mixer 802 includes at least two mixers, at least one phase shifter, and at least one combiner (e.g., a summation circuit). The filter 804 attenuates intermodulation products that are generated by the in-phase and quadrature mixer 802. In an example implementation, the filter 804 is implemented using a low-pass filter.

The pre-processing module 518 can optionally include at least one frequency selector 806. The frequency selector 806 can identify and select one or more tones 704 (or carrier frequencies) that provide a high-quality signal for later processing. The frequency selector 806 can further pass the selected tones to other processing modules (e.g., the gesture-recognition module 520) and filter (or attenuate) other tones that are not selected. The frequency selector 806 can include at least one amplitude detector 808, at least one phase detector 810, at least one quality detector 812, and at least one comparator 814. The operations of these components are further described below.

For gesture recognition 112, the in-phase and quadrature mixer 802 uses the phase shifter and the two mixers to generate in-phase and quadrature components associated with the digital receive signal 708. In particular, the in-phase and quadrature mixer 802 mixes the digital receive signal 708 with a first version of the digital transmit signal 706 that has a zero-degree phase shift to generate the in-phase component. Additionally, the in-phase and quadrature mixer 802 mixes the digital receive signal 708 with a second version of the digital transmit signal 706 that has a 180-degree phase shift to generate the quadrature signal. This mixing operation downconverts the digital receive signal 708 from acoustic frequencies to baseband frequencies. Using the combiner, the in-phase and quadrature mixer 802 combines the in-phase and quadrature components of the digital receive signal 708 to generate a down-converted signal 816. Use of the in-phase and quadrature mixer 802 can further improve the signal-to-noise ratio of the down-converted signal 816 compared to other mixing techniques.

In this example, the down-converted signal 816 represents a combination of the in-phase and quadrature components of the mixed-down digital receive signal 708. In alternative implementations, the in-phase and quadrature mixer 802 doesn't include the combiner and passes the in-phase and quadrature components separately to the filter 804. In this manner, the in-phase and quadrature components individually propagate through the filter 804.

The filter 804 generates a filtered signal 818 based on the down-converted signal 816. In particular, the filter 804 filters the down-converted signal 816 to attenuate spurious or undesired frequencies (e.g., intermodulation products), some of which can be associated with an operation of the in-phase and quadrature mixer 802. In this example, the filtered signal 818 represents a combination of the in-phase and quadrature components of the down-converted signal 816. Alternatively, the filtered signal 818 can represent separate or distinct in-phase and quadrature components, which are individually passed to the frequency selector 806.

The frequency selector 806 extracts an amplitude 820 of the filtered signal 818 using the amplitude detector 808 and extracts a phase 822 of the filter signal 818 using the phase detector 810. Alternatively, if in-phase and quadrature components of the filter signal 818 are received separately, the amplitude detector 808 and the phase detector 810 can respectively measure the amplitude 820 and phase 822 based on the in-phase and quadrature components.

The quality detector 812 determines quality metrics 824-1 to 824-2M for each of the tones 704-1 to 704-M and for each of the characteristics (e.g., amplitude 820 and phase 822). Various quality metrics 824 can be include signal-to-noise ratios, peak-to-average ratios, and so forth. A higher quality metric 824 indicates a higher-quality signal, or more generally, better performance for gesture recognition 112.

In one aspect, the comparator 814 can evaluate the quality metrics 824-1 to 824-2M with respect to a threshold 826. The threshold 826 can be set, for example, to a particular value that improves performance for gesture recognition 112. In other cases, the frequency selector 806 can dynamically determine the threshold 826 and update it over time based on the observed quality metrics 824-1 to 824-2M. In an example implementation, the comparator 814 selects tones 828-1 to 828-N for use in gesture recognition 112 based on the frequencies associated with the quality metrics 824-1 to 824-2M that are greater than or equal to the threshold 826.

Additionally or alternatively, the comparator 814 can evaluate the quality metrics 824-1 to 824-2M with respect to each other. In an example implementation, the comparator 814 determines one of the selected tones 828 based on a frequency with the highest quality metric 824 across the amplitude 820. Also, the comparator 814 can determine one of the selected tones 828 based on a frequency with the highest quality metric 824 across the phase 822. In other implementations, the comparator 814 can determine a single selected tone 828 based on a frequency having the highest quality metric 824 associated with either the amplitude 820 or the phase 822.

The comparator 814 generates the pre-processed signal 710 having the selected tones 828-1 to 828-N. The tones 828-1 to 828-N can represent a subset (sometimes a proper subset) of the tones 704-1 to 704-M. The pre-processed signal 710 can represent a filtered version of the filtered signal 818.

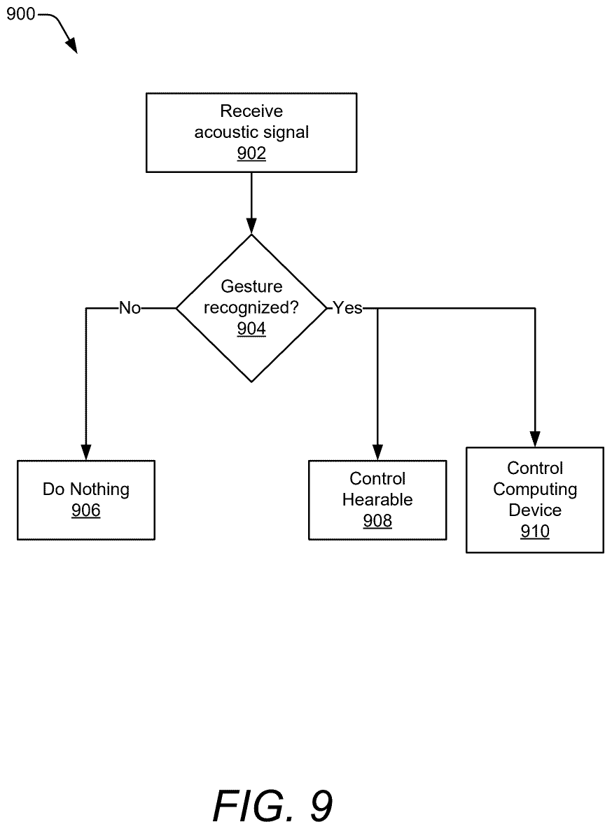

In general, the frequency selector 806 enables the selected tones 828-1 to 828-N to be dynamically determined based on a current environment, which can account for a wear of the hearable 102 (e.g., a current insertion depth and/or rotation), a physical structure of the user 106's ear canal 114, and a response characteristic of the hearable 102 (e.g., speaker, microphone, and/or housing). In this manner, the frequency selector 806 can improve signal-to-noise ratio performance of the hearable 102 for the gesture recognition 112. Through this frequency selection process, the hearables 102 on different ears 108 may perform gesture recognition 112 with pre-processed signals 710 having one or more different tones 828. Gesture recognition 112 can be used to control an operation of the hearable 102 and/or to control an operation of the computing device 104, as further described with respect to FIG. 9.

### Gesture-Based Control

FIG. 9 illustrates an example scheme 900 for performing gesture-based control. At 902, the hearable 102 receives the acoustic receive signal 604. At 904, the gesture-recognition module 520 recognizes or does not recognize a gesture based on the acoustic receive signal 604. If the gesture-recognition module 520 does not recognize (or detect) a gesture, no action is taken at 906. If the gesture-recognition module 520 recognizes the gesture, the gesture-based control module 522 of the hearable 102 or the gesture-based control module 408 of the computing device 104 can perform an action depending on the input primitive 302 that is mapped to the gesture. In one example, the gesture-based control module 522 controls an aspect of the hearable 102 based on the recognized gesture 712 at 908. For example, the gesture-recognition module 520 can perform any of the controls described above with respect to FIG. 3 based on recognized gesture 712.

In another example, the gesture-based control module 408 controls an aspect of the computing device 104 at 910. For example, the gesture-based control module 408 can control an aspect of the computing device 104 based on the recognized gesture 712. For example, the gesture-based control module 408 can perform any of the controls described above with respect to FIG. 3. An interaction between the gesture-recognition module 520 and the gesture-based control modules 408 and/or 522 is further described with respect to FIG. 10.

FIG. 10 illustrates example communications between a gesture-recognition module 520 and one or more gesture-based control modules 408 and/or 522. At 1002, the gesture-based control module 408 and/or 522 can optionally provide the gesture-recognition module 520 with a list of supported gestures 1004. The supported gestures 1004 include muscle-based gestures 212 and/or object-based gestures 244 that are mapped to an input primitive 302. In some cases, the list of supported gestures 1004 can be used by the gesture-recognition module 520 to avoid reporting gestures that are not supported. Optionally, the list of supported gestures 1004 can be provided as an input to the machine-learned model 702.

At 1006, the gesture-recognition module 520 performs gesture recognition 112, as described above with respect to FIG. 7. At 1008, the gesture-recognition module 520 provides the recognized gesture 712, as determined at 1006, to the gesture-based control module 408 and/or 522.

The gesture-based control module 408 and/or 522 maps the recognized gesture 712 to an input primitive 302. Additionally, the gesture-based control module 408 and/or 522 performs input primitive and control mapping at 1010. This means that the gesture-based control module 408 and/or 522 maps the input primitive 302 to a control. The gesture-based control module 408 and/or 522 can generate a control signal that causes a device associated with that input primitive 302 and/or recognized gesture 712 to enact the identified control.

FIGS. 11-1 to 16 illustrate the impact of various muscle-based gestures 212 and object-based gestures 244 on an acoustic receive signal 604. More specifically, the FIGS. 11-1 to 16 depict example amplitudes 820 and phases 822 of pre-processed signals 710 generated by different hearables 102-1 and 102-2. As shown below, the pressure wave caused by the gesture can significantly impact the amplitude 820 and/or the phase 822 of the pre-processed signals 710. In some instances, the change in the amplitude 820 and/or the phase 822 can be relative to a previous state or relative to a previous trend in the amplitude 820 and/or the phase 822. The previous state can refer to values of the amplitude 820 and/or the phase 822 during which the user 106 does not perform a gesture.

In general, the term “significantly” can mean that the values of the amplitude 820 and/or the phase 822 can change by 20% or more relative to a previous value (e.g., relative to an average of a set of previous values). Additionally or alternatively, a slope of the amplitude 820 and/or the phase 822 can vary significantly. Sometimes the slope of the amplitude 820 and/or the phase 822 can change signs (e.g., from a positive slope to a negative slope, or vice versa). A magnitude of the slope of the amplitude 820 and/or the phase 822 can sometimes change by approximately 10% or more.

In some implementations, the gesture-recognition module 520 can detect and recognize the gesture based on the amplitude 820 of the pre-processed signal 710 provided by the hearable 102-1, the phase 822 of the pre-processed signal 710 provided by the hearable 102-1, the amplitude of the pre-processed signal 710 provided by the hearable 102-2, the phase 822 of the pre-processed signal 710 provided by the hearable 102-2, or some combination thereof. Generally speaking, processing a larger quantity of signals and/or tones 704 that are sensitive to the pressure wave caused by the gesture provides more information to the gesture-recognition module 520. This can make it easier for the gesture-recognition module 520 to accurately recognize the gesture.

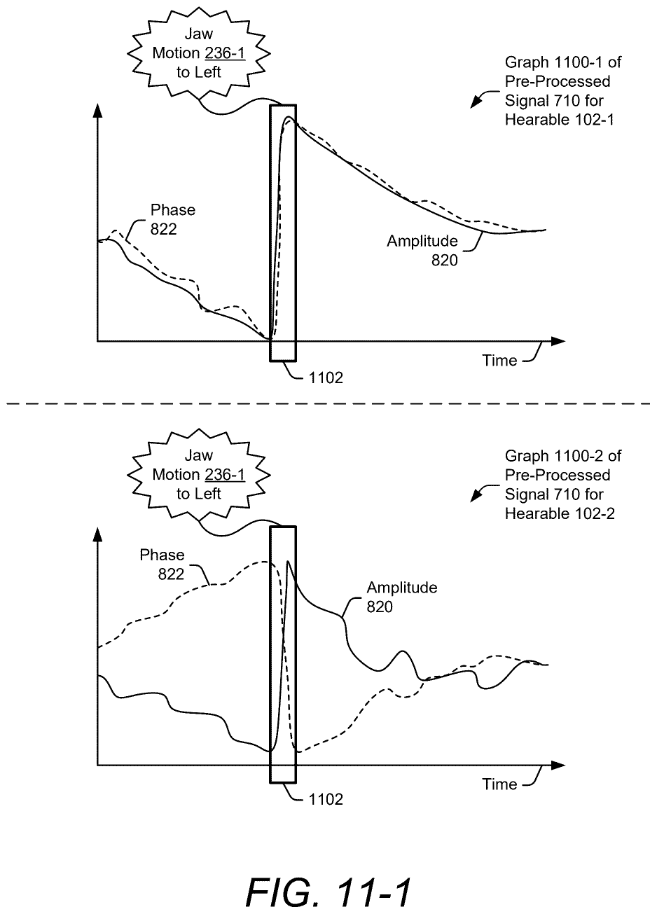

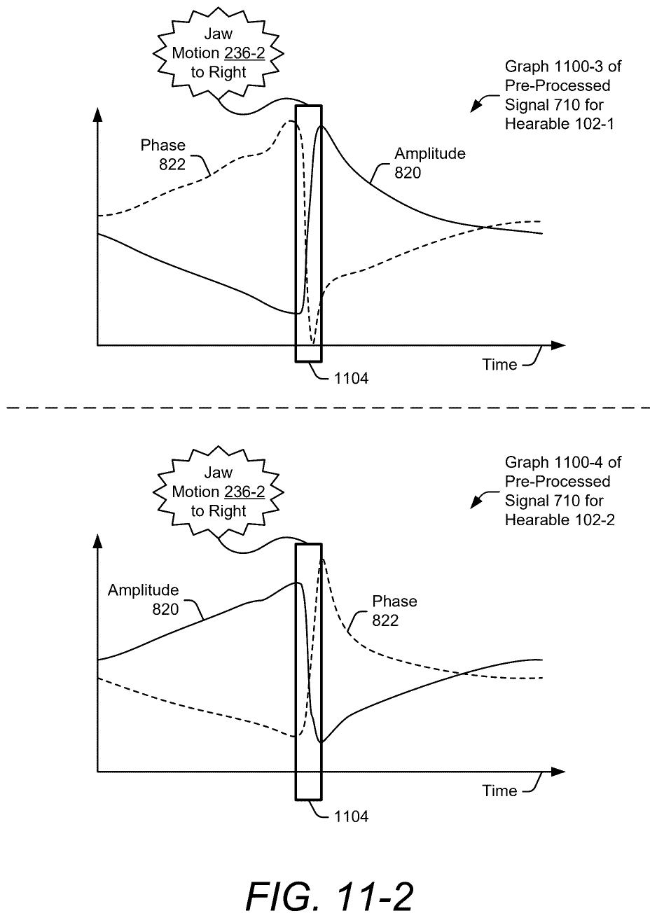

FIG. 11-1 illustrates example pre-processed signals 710 associated with a first muscle-based gesture 212 involving jaw movement. Graphs 1100-1 and 1100-2 depict amplitudes 820 and phases 822 of pre-processed signals 710 that are respectively generated by the hearables 102-1 and 102-2. Time is depicted along the horizontal axes of the graphs 1100-1 and 1100-2.

During the time interval indicated at 1102, the user 106 performs a first jaw motion 236-1, which involves moving their jaw to the left. This causes the amplitude 820 and/or the phase 822 of the acoustic receive signal 604 to change significantly relative to a previous state. With audioplethysmography 110, the gesture-recognition module 520 can detect and recognize the first jaw motion 236-1 based on the change in the amplitude 820 and/or phase 822 of the pre-processed signals 710 provided by the hearable 102-1 and/or the hearable 102-2.

FIG. 11-2 illustrates example pre-processed signals 710 associated with a second muscle-based gesture 212 involving jaw movement. Graphs 1100-3 and 1100-4 depict amplitudes 820 and phases 822 of pre-processed signals 710 that are respectively generated by the hearables 102-1 and 102-2. Time is depicted along the horizontal axes of the graphs 1100-3 and 1100-4.

During the time interval indicated at 1104, the user 106 performs a second jaw motion 236-2, which involves moving their jaw to the right. This causes the amplitude 820 and/or the phase 822 of the acoustic receive signal 604 to change significantly relative to a previous state. With audioplethysmography 110, the gesture-recognition module 520 can detect and recognize the second jaw motion 236-2 based on the change in the amplitude 820 and/or phase 822 of the pre-processed signals 710 provided by the hearable 102-1 and/or the hearable 102-2.

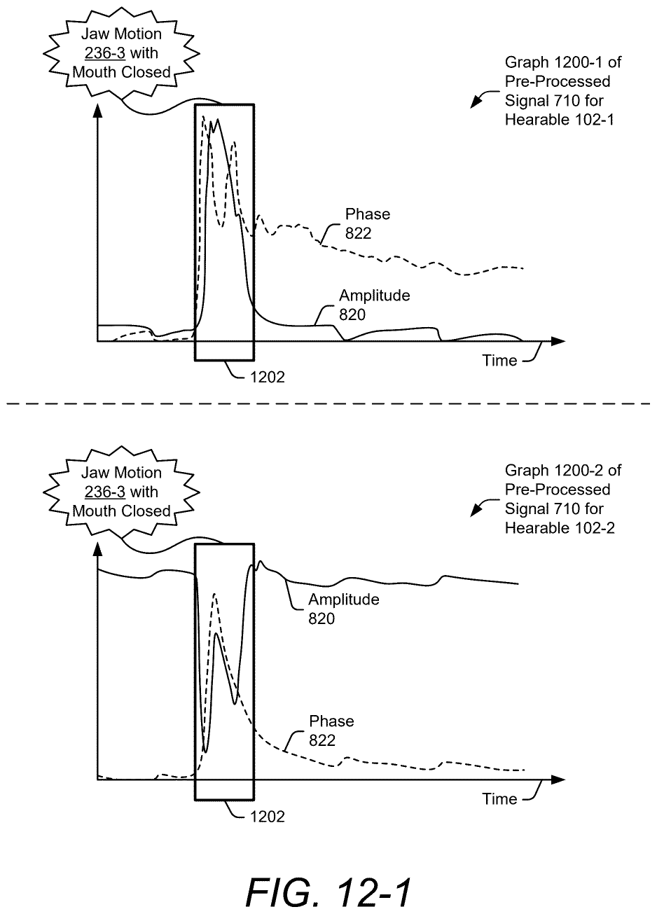

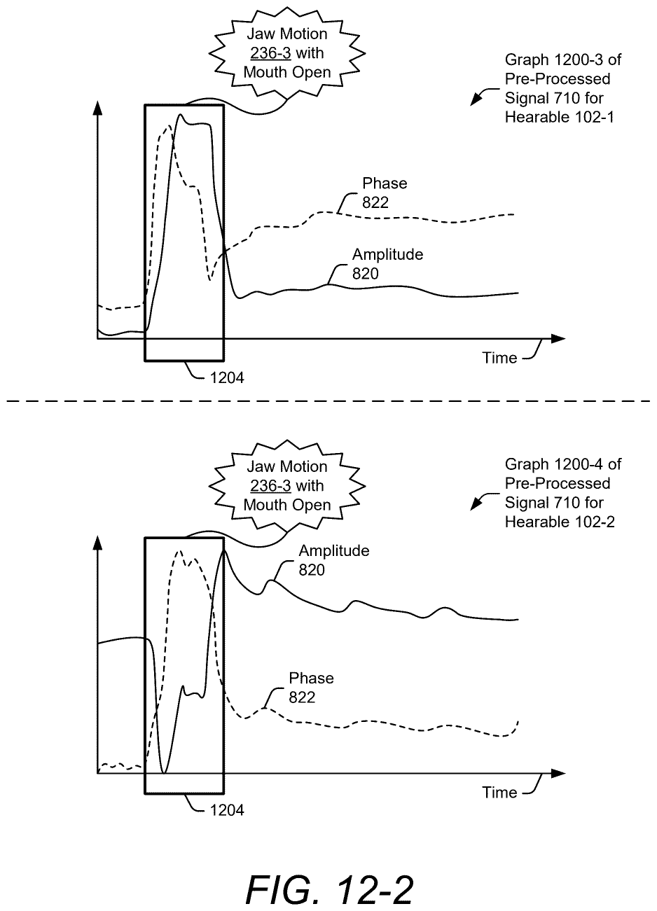

FIG. 12-1 illustrates example pre-processed signals 710 associated with a third muscle-based gesture 212 involving jaw movement with a closed mouth. Graphs 1200-1 and 1200-2 depict amplitudes 820 and phases 822 of pre-processed signals 710 that are respectively generated by the hearables 102-1 and 102-2. Time is depicted along the horizontal axes of the graphs 1200-1 and 1200-2.

During the time interval indicated at 1202, the user 106 performs a third jaw motion 236-3, which involves opening their jaw, while their mouth is closed. This causes the amplitude 820 and/or the phase 822 of the acoustic receive signal 604 to change significantly relative to a previous state. With audioplethysmography 110, the gesture-recognition module 520 can detect and recognize the third jaw motion 236-3 based on the change in the amplitude 820 and/or phase 822 of the pre-processed signals 710 provided by the hearable 102-1 and/or the hearable 102-2.

FIG. 12-2 illustrates example pre-processed signals 710 associated with the third muscle-based gesture 212 involving jaw movement with an open mouth. Graphs 1200-3 and 1200-4 depict amplitudes 820 and phases 822 of pre-processed signals 710 that are respectively generated by the hearables 102-1 and 102-2. Time is depicted along the horizontal axes of the graphs 1200 3 and 1200-4.

During the time interval indicated at 1204, the user 106 performs the third jaw motion 236-3, which involves opening their jaw, while their mouth is open. This causes the amplitude 820 and/or the phase 822 of the acoustic receive signal 604 to change significantly relative to a previous state. With audioplethysmography 110, the gesture-recognition module 520 can detect and recognize the third jaw motion 236-3 based on the change in the amplitude 820 and/or phase 822 of the pre-processed signals 710 provided by the hearable 102-1 and/or the hearable 102-2.

In some cases, the third jaw motion 236-3 shown in FIGS. 12-1 and 12-2 can represent a same muscle-based gesture 212, regardless of whether or not the user 106's mouth is open or closed. In other cases, the third jaw motion 236-3 shown in FIGS. 12-1 and 12-2 can represent different muscle-based gestures 212 based on whether the user 106's mouth is open or closed.

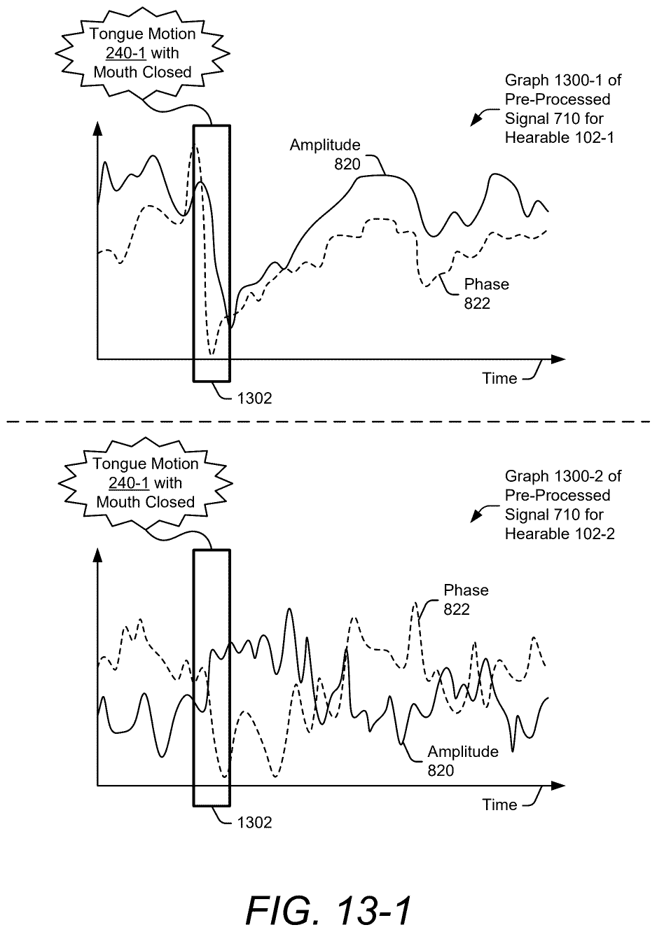

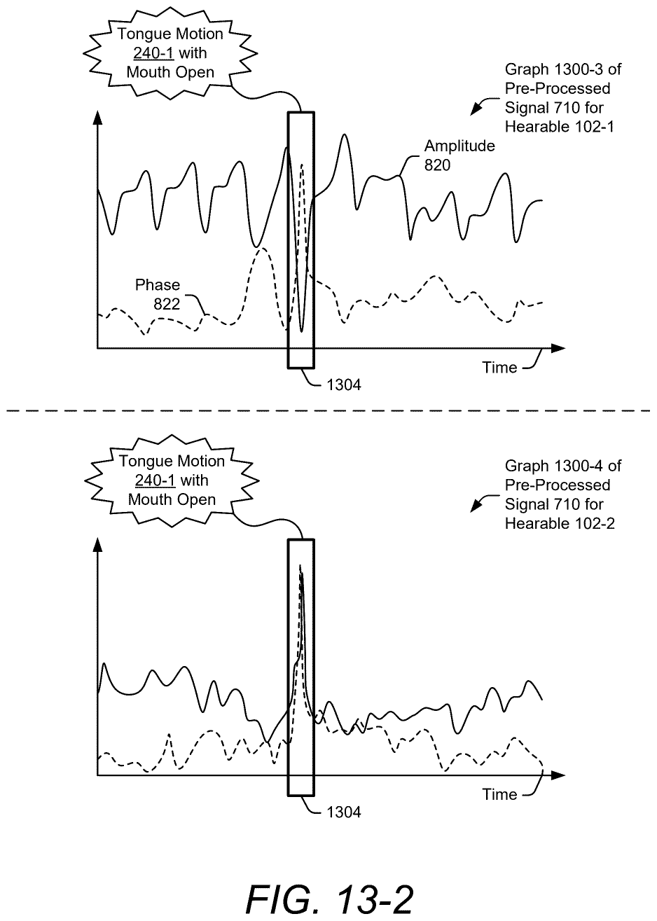

FIG. 13-1 illustrates example pre-processed signals 710 associated with a fourth muscle-based gesture 212 involving tongue movement with a closed mouth. Graphs 1300-1 and 1300-2 depict amplitudes 820 and phases 822 of pre-processed signals 710 that are respectively generated by the hearables 102-1 and 102-2. Time is depicted along the horizontal axes of the graphs 1300-1 and 1300-2.

During the time interval indicated at 1302, the user 106 performs a first tongue motion 240-1, which involves clicking their tongue, while their mouth is closed. This causes the amplitude 820 and/or the phase 822 of the acoustic receive signal 604 to change significantly relative to a previous state. With audioplethysmography 110, the gesture-recognition module 520 can detect and recognize the first tongue motion 240-1 based on the change in the amplitude 820 and/or phase 822 of the pre-processed signals 710 provided by the hearable 102-1 and/or the hearable 102-2.

Some characteristics of the pre-processed signals 710 can be easier to process for gesture recognition 112 compared to others. For example, the amplitude 820 and the phase 822 of the pre-processed signal 710 provided by the hearable 102-1 shows a larger change due to the tongue motion 240-1 compared to the amplitude 820 and/or the phase 822 of the pre-processed signal 710 provided by the hearable 102-2. The gesture-recognition module 520 can at least recognize the tongue motion 240-1 based on the amplitude 820 and/or the phase 822 of the pre-processed signal 710 provided by the hearable 102-1. In various implementations, the gesture-recognition module 520 may or may not use the pre-processed signal 710 provided by the hearable 102-2.

FIG. 13-2 illustrates example pre-processed signals 710 associated with the fourth muscle-based gesture involving tongue movement with an open mouth. Graphs 1300-3 and 1300-4 depict amplitudes 820 and phases 822 of pre-processed signals 710 that are respectively generated by the hearables 102-1 and 102-2. Time is depicted along the horizontal axes of the graphs 1300-3 and 1300-4.

During the time interval indicated at 1304, the user 106 performs the first tongue motion 240-1, which involves clicking their tongue, while their mouth is open. This causes the amplitude 820 and/or the phase 822 of the acoustic receive signal 604 to change significantly relative to a previous state. With audioplethysmography 110, the gesture-recognition module 520 can detect and recognize the first tongue motion 240-1 based on the change in the amplitude 820 and/or phase 822 of the pre-processed signals 710 provided by the hearable 102-1 and/or the hearable 102-2.

In some cases, the first tongue motion 240-1 shown in FIGS. 13-1 and 13-2 can represent a same muscle-based gesture 212, regardless of whether or not the user 106's mouth is open or closed. In other cases, the first tongue motion 240-1 shown in FIGS. 13-1 and 13-2 can represent different muscle-based gestures 212 based on whether the user 106's mouth is open or closed.

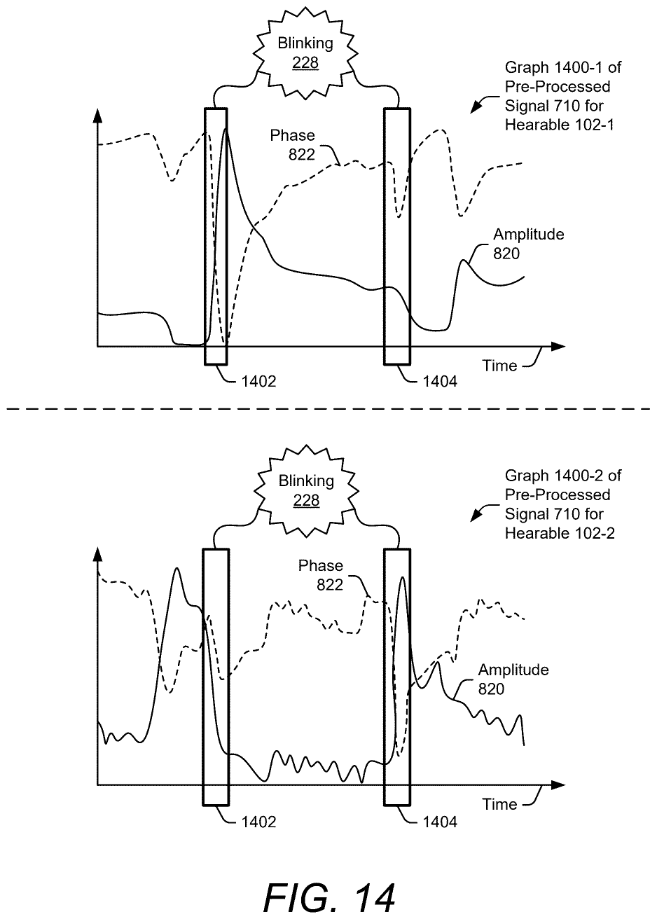

FIG. 14 illustrates example pre-processed signals 710 associated with a fifth muscle-based gesture 212 involving eye-region motion 226. Graphs 1400-1 and 1400-2 depict amplitudes 820 and phases 822 of pre-processed signals 710 that are respectively generated by the hearables 102-1 and 102-2. Time is depicted along the horizontal axes of the graphs 1400-1 and 1400-2.

During the time intervals indicated at 1402 and 1404, the user 106 blinks 228. This causes the amplitude 820 and/or the phase 822 of the acoustic receive signal 604 to change significantly relative to a previous state. With audioplethysmography 110, the gesture-recognition module 520 can detect and recognize the blinking 228 based on the change in the amplitude 820 and/or phase 822 of the pre-processed signals 710 provided by the hearable 102-1 and/or the hearable 102-2.

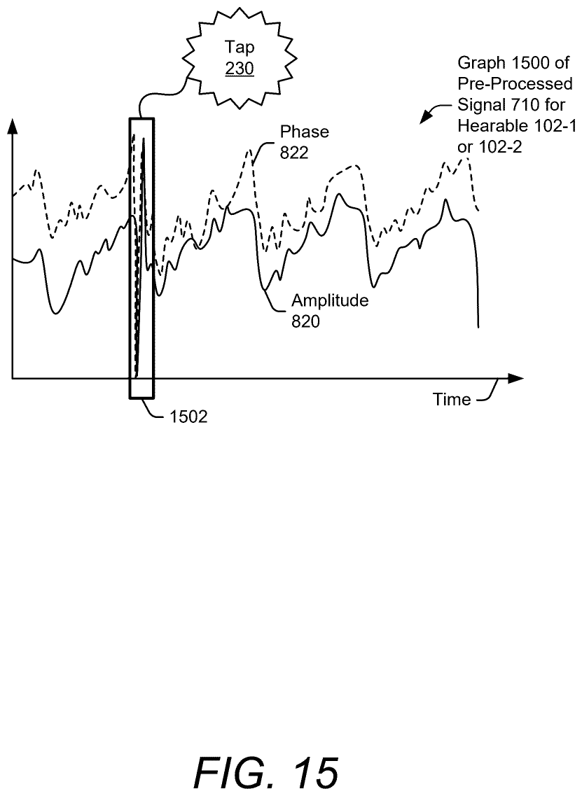

FIG. 15 illustrates an example pre-processed signal 710 associated with a first object-based gesture 244 involving a tap 250. Graph 1500 depicts an amplitude 820 and a phase 822 of a pre-processed signal 710 that is generated by the hearable 102-1 or 102-2. Time is depicted along the horizontal axes of the graph 1500.

During the time interval indicated at 1502, the user 106 taps 230, using the object 246 and/or the appendage 248, a portion of their upper body 202, which can be somewhere on their face or on their upper torso region 208 (e.g., on their ear 108's helix, cheek, or jaw). This causes the amplitude 820 and/or the phase 822 of the acoustic receive signal 604 to change significantly relative to a previous state. With audioplethysmography 110, the gesture-recognition module 520 can detect and recognize the tap 250 based on the change in the amplitude 820 and/or phase 822 of the pre-processed signals 710 provided by the hearable 102-1 and/or the hearable 102-2.

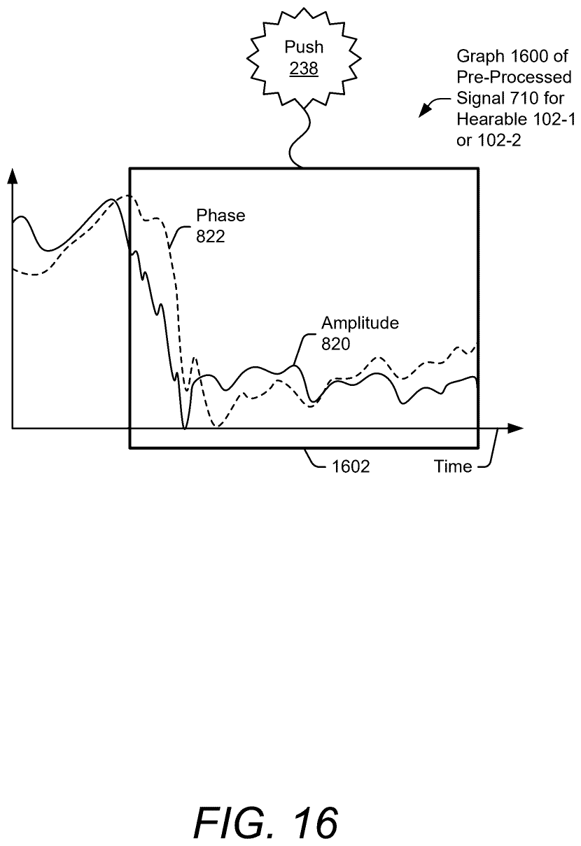

FIG. 16 illustrates an example pre-processed signal 710 associated with a second object-based gesture 244 involving a push 258. Graph 1600 depicts an amplitude 820 and a phase 822 of a pre-processed signal 710 that is generated by the hearable 102-1 or 102-2. Time is depicted along the horizontal axes of the graph 1600.

During the time interval indicated at 1602, the user 106 rests their chin on their hand. This causes the amplitude 820 and/or the phase 822 of the acoustic receive signal 604 to change significantly relative to a previous state. With audioplethysmography 110, the gesture-recognition module 520 can detect and recognize the push 258 based on the change in the amplitude 820 and/or phase 822 of the pre-processed signals 710 provided by the hearable 102-1 and/or the hearable 102-2.

The signals depicted within the graphs of FIGS. 11-1 to 16 are associated with a particular tone 704. In some cases, multiple tones 704 of the acoustic receive signal 604 are used to detect and recognize the gesture. The signals depicted in FIGS. 11-1 and 16 generally represent smoothed data. Signals that are generated using audioplethysmography 110 can have additional noise that is not depicted in the graphs of FIGS. 11-1 to 16 for simplicity and clarity. In most of the signals depicted in FIGS. 11-1 and 16, both the amplitude 820 and the phase 822 are impacted by the gesture and can be used for gesture recognition 112. Sometimes, however, only one of the amplitude 820 or the phase 822 are impacted by the gesture. However, gesture recognition 112 can still be performed in this instance. Also, sometimes only one of the hearables 102-1 or 102-2 are impacted by the gesture. If the amplitude 820 and/or the phase 822 of a pre-processed signal 710 do not show a significant impact based on the gesture 212, the gesture-recognition module 520 can rely on other tones 704 or other pre-processed signals 710 (e.g., provided by a different hearable 102) to perform gesture recognition 112.

### Example Methods

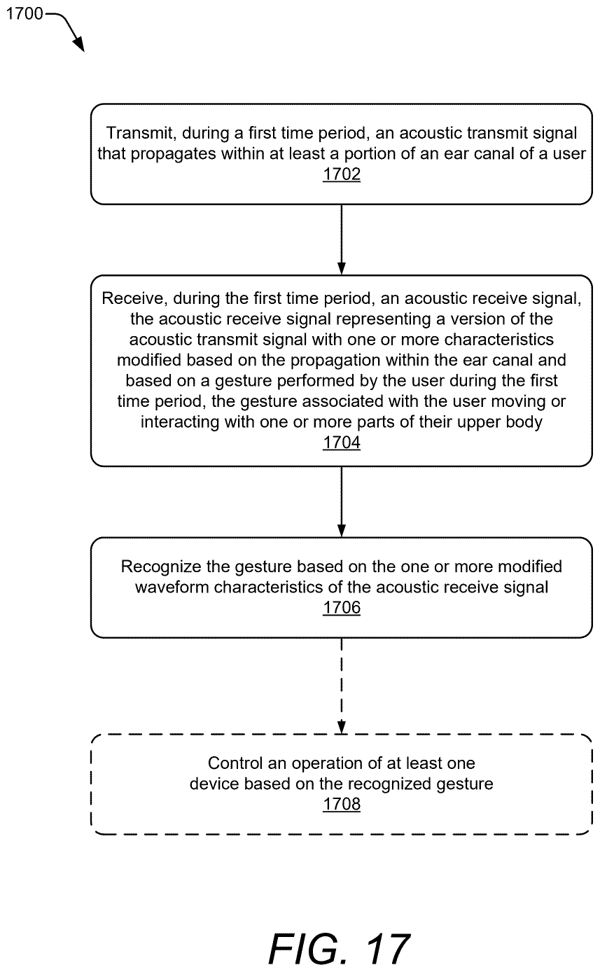

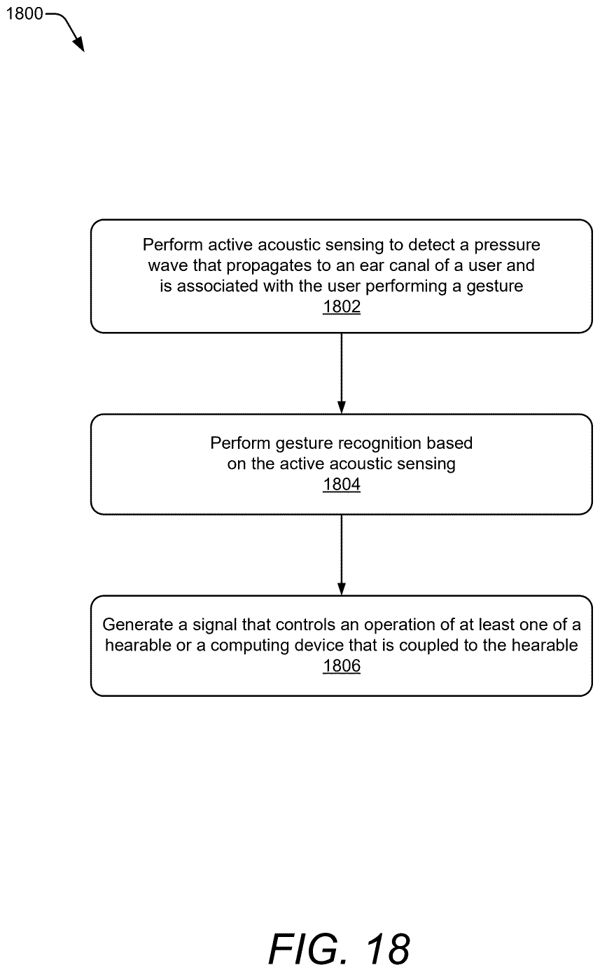

FIGS. 17 and 18 depict example methods 1700 and 1800 for implementing aspects of gesture-based control using active acoustic sensing. Methods 1700 and 1800 are shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environments 200-1 and 200-2 of FIGS. 2-1 and 2-2, and entities detailed in FIGS. 4 and 5, reference to which is made for example only. The techniques are not limited to performance by one entity or multiple entities operating on one device.

At 1702, an acoustic transmit signal is transmitted during a first time period. The acoustic transmit signal propagates within at least a portion of an ear canal of a user. For example, the transducer 506 (or speaker 508) of the hearable 102 transmits the acoustic transmit signal 602 during the first time period. The acoustic transmit signal 602 propagates within at least a portion of the ear canal 114 of the user 106, as described with respect to FIG. 6. The acoustic transmit signal 602 can include multiple tones 704-1 to 704-M to improve a likelihood of detecting a muscle-based gesture 212 performed by the user 106.

At 1704, an acoustic receive signal is received during the first time period. The acoustic receive signal represents a version of the acoustic transmit signal with one or more waveform characteristics modified based on the propagation within the ear canal and based on a gesture performed by the user during the first time period. The gesture is associated with the user moving or interacting with one or more parts of their upper body.

For example, the transducer 506 (or the microphone 510) of the hearable 102 receives the acoustic receive signal 604 during the first time period. The acoustic receive signal 604 represents a version of the acoustic transmit signal 602 with one or more waveform characteristics modified based on the propagation within the ear canal 114 and based on the muscle-based gesture 212 and/or the object-based gesture 244 performed by the user 106 during the first time period. The hearable 102 that receives the acoustic receive signal 604 can be a same hearable 102 that transmitted the acoustic transmit signal 602 (e.g., the hearable 102-1 or 102-2 in FIG. 6), or another hearable 102 that did not transmit the acoustic transmit signal 602 (e.g., the hearable 102-2 in FIG. 6). Example waveform characteristics include amplitude 820, phase 822, and/or frequency. In some implementations, a feedback microphone of an active-noise-cancellation circuit 524 can receive the acoustic receive signal 604.

The muscle-based gesture 212 involves the user 106 moving one or more parts of their upper body 202, as shown in FIG. 2-1. In general, the muscle-based gesture 212 does not involve the user 106 moving an appendage, such as their arm or their hand. It also does not involve the user 106 using their hand or an object to touch (e.g., tap) or otherwise interact with a portion of their upper body 202. The muscles that the user 106 engages to perform a muscle-based gesture 212 can include those in the upper torso region 208, the neck 206, and/or the head 204 (including the face).

The object-based gesture 244 involves the user 106 using an object 246 and/or an appendage 248 to interact with (e.g., to touch) one or more parts of their upper body 202, as shown in FIG. 2-2. In general, the object-based gesture 244 involves the user 106 pressing the object 246 and/or the appendage 248 somewhere on their upper body 202. The parts of the upper body 202 in which the user 106 can interact with to perform an object-based gesture 244 can include those in the upper torso region 208, the neck 206, and/or the head 204 (including the face).

At 1706, the gesture is recognized based on the one or more modified waveform characteristics of the acoustic receive signal. For example, the gesture-recognition module 520 recognizes the gesture performed by the user 106 based on the one or more modified waveform characteristics of the acoustic receive signal 604.

Optionally at 1708, an operation of at least one device is controlled based on the recognized gesture. For example, the recognized gesture can be used to control an operation of the hearable 102 and/or an operation of the computing device 104, as described with respect to FIG. 3.

At 1802 in FIG. 18, active acoustic sensing is performed to detect a pressure wave that propagates to an ear canal of a user and is associated with the user performing a gesture. For example, the hearable 102 performs active acoustic sensing to detect the pressure wave that propagates to the ear canal 114 of the user 106 and is associated with the user 106 performing the gesture. More specifically, the hearable 102 transmits and receives the acoustic signal during the first time period. The acoustic signal propagates within at least a portion of the ear canal 114 of the user 106. The received acoustic signal (e.g., the acoustic receive signal 604) represents a version of the transmitted acoustic signal (e.g., the acoustic transmit signal 602) with one or more characteristics (e.g., amplitude 820 and/or phase 822) modified based on the propagation within the ear canal 114 and based on the user 106 performing a muscle-based gesture 212 during at least a portion of the first time period. The gesture can be a muscle-based gesture 214 and/or an object-based gesture 244.

At 1804, gesture recognition is performed based on the active acoustic sensing. For example, the gesture-recognition module 520 performs gesture recognition 112 based on the active acoustic sensing (e.g., based on the version of the acoustic receive signal 604, such as the pre-processed signal 710).

At 1806, a signal that controls an operation of at least one of a hearable or a computing device that is coupled to the hearable is generated. For example the gesture-based control module 408 and/or 522 generates a control signal to control an operation of the computing device 104 and/or the hearable 102, respectively.

### Example Computing System

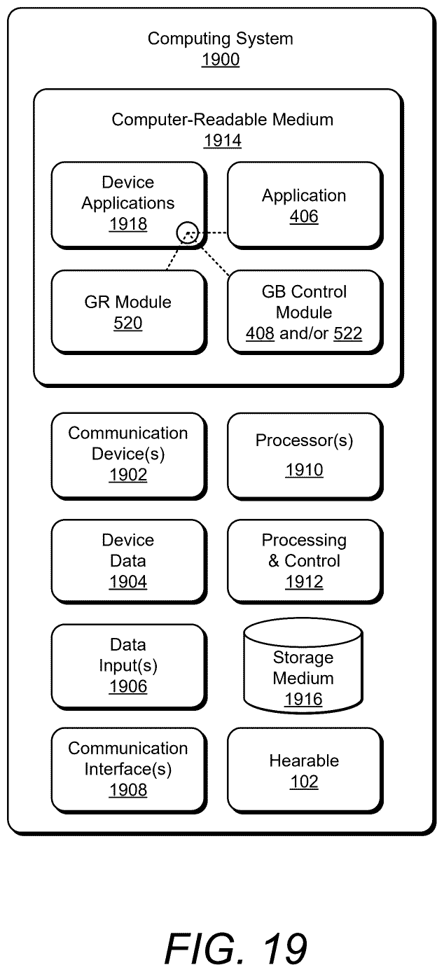

FIG. 19 illustrates various components of an example computing system 1900 that can be implemented as any type of client, server, and/or computing device as described with reference to the previous FIGS. 4 and 5 to implement aspects of gesture recognition 112 using active acoustic sensing.

The computing system 1900 includes communication devices 1902 that enable wired and/or wireless communication of device data 1904 (e.g., received data, data that is being received, data scheduled for broadcast, or data packets of the data). The communication devices 1902 or the computing system 1900 can include one or more hearables 102. The device data 1904 or other device content can include configuration settings of the device, media content stored on the device, and/or information associated with a user of the device. Media content stored on the computing system 1900 can include any type of audio, video, and/or image data. The computing system 1900 includes one or more data inputs 1906 via which any type of data, media content, and/or inputs can be received, such as human utterances, user-selectable inputs (explicit or implicit), messages, music, television media content, recorded video content, and any other type of audio, video, and/or image data received from any content and/or data source.

The computing system 1900 also includes communication interfaces 1908, which can be implemented as any one or more of a serial and/or parallel interface, a wireless interface, any type of network interface, a modem, and as any other type of communication interface. The communication interfaces 1908 provide a connection and/or communication links between the computing system 1900 and a communication network by which other electronic, computing, and communication devices communicate data with the computing system 1900.

The computing system 1900 includes one or more processors 1910 (e.g., any of microprocessors, controllers, and the like), which process various computer-executable instructions to control the operation of the computing system 1900. Alternatively or in addition, the computing system 1900 can be implemented with any one or combination of hardware, firmware, or fixed logic circuitry that is implemented in connection with processing and control circuits which are generally identified at 1912. Although not shown, the computing system 1900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1900 also includes a computer-readable medium 1914, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 1900 can also include a mass storage medium device (storage medium) 1916.

The computer-readable medium 1914 provides data storage mechanisms to store the device data 1904, as well as various device applications 1918 and any other types of information and/or data related to operational aspects of the computing system 1900. For example, an operating system can be maintained as a computer application with the computer-readable medium 1914 and executed on the processors 1910. The device applications 1918 may include a device manager, such as any form of a control application, software application, signal-processing and control module, code that is native to a particular device, a hardware abstraction layer for a particular device, and so on.

The device applications 1918 also include any system components, engines, or managers to implement gesture recognition 112. In this example, the device applications 1918 include the application 406 of FIG. 4, the gesture-recognition module 520 (GR module 520) of FIG. 5, and the gesture-based control modules 408 and/or 522 (GB control modules 408 and/or 522).

Throughout this disclosure, examples are described where a computing system 1900 (e.g., the hearable 102, the computing device 104, a client device, a server device, a computer, or another type of computing system) may analyze information (e.g., various audible and/or ultrasound signals) associated with a user, for example, the muscle-based gestures 212 or the object-based gestures 244 mentioned with respect to FIGS. 2-1 and 2-2. Further to the descriptions above, a user 106 may be provided with controls allowing the user 106 to make an election as to both if and when systems, programs, and/or features described herein may enable collection of information (e.g., information about a user's social network, social actions, social activities, profession, a user's preferences, a user's current location), and if the user is sent content or communications from a server. The computing system 1900 can be configured to only use the information after the computing system 1900 receives explicit permission from the user 106 to use the data. For example, in situations where the hearable 102 analyzes signals for gesture recognition 112, individual users 106 may be provided with an opportunity to provide input to control whether programs or features of the computing system 1900 can collect and make use of the data. Further, individual users 106 may have constant control over what programs can or cannot do with the information.

In addition, information collected may be pre-treated in one or more ways before it is transferred, stored, or otherwise used, so that personally-identifiable information is removed. For example, before the computing system 1900 shares data with another device, a user 106's identity may be treated so that no personally identifiable information can be determined for the user 106. Thus, the user 106 may have control over whether information is collected about the user 106 and the user 106's device, and how such information, if collected, may be used by the computing system 1900 and/or a remote computing system.

### CONCLUSION

Although techniques using, and apparatuses including, gesture-based control using active acoustic sensing have been described in language specific to features and/or methods, it is to be understood that the subject of the appended claims is not necessarily limited to the specific features or methods described. Rather, the specific features and methods are disclosed as example implementations of gesture-based control using active acoustic sensing.

Some examples are provided below.

Example 1: A method comprising:
transmitting, during a first time period, an acoustic transmit signal that propagates within at least a portion of an ear canal of a user;
receiving, during the first time period, an acoustic receive signal, the acoustic receive signal representing a version of the acoustic transmit signal with one or more waveform characteristics modified based on the propagation within the ear canal and based on a gesture performed by the user during the first time period, the gesture associated with the user moving and/or interacting with one or more parts of their upper body; and
recognizing the gesture based on the one or more modified waveform characteristics of the acoustic receive signal; and
controlling an operation of at least one device based on the recognized gesture.

Example 2: The method of example 1, wherein the controlling the operation of the at least one device comprises at least one of the following:
controlling an operation of a hearable based on the recognized gesture; or
controlling an operation of a computing device based on the recognized gesture.

Example 3: The method of example 2, further comprising:
determining that gesture-based control of the hearable is enabled; and
responsive to the determination, controlling the operation of the hearable based on the recognized gesture.

Example 4: The method of example 2, further comprising:
determining that gesture-based control of the hearable is disabled; and
responsive to the determination, controlling the operation of the computing device based on the recognized gesture.

Example 5: The method of examples 3 and 4, further comprising:
determining whether gesture-based control of the hearable is enabled or disabled; and,
responsive to the determination, either controlling the operation of the hearable based on the recognized gesture if the gesture-based control of the hearable is enabled, or controlling the operation of the computing device based on the recognized gesture if gesture-based control of the hearable is disabled.

Example 6: The method of any one of examples 2 to 5, further comprising:
mapping the recognized gesture to an input primitive, the input primitive comprising a selection input primitive, wherein:
the controlling of the operation of the hearable comprises controlling a volume of the hearable based on the mapping of the recognized gesture to the selection input primitive; and/or
the controlling of the operation of the computing device comprises scrolling through content that is presented on a display of the computing device based on the mapping of the recognized gesture to the selection input primitive.

Example 7: The method of example 6, wherein:
the controlling the volume of the hearable comprises increase or decreasing the volume of the hearable based on a direction associated with the recognized gesture; and
the scrolling through the content comprises scrolling through the content based on the direction associated with the recognized gesture.

Example 8: The method of any one of examples 2 to 5, wherein:
the mapping of the recognized gesture to the input primitive comprises mapping the recognized gesture to a confirmation input primitive;
the controlling of the operation of the hearable comprises controlling a presentation of audible content based on the mapping of the recognized gesture to the confirmation input primitive, the controlling the presentation of the audible content comprising selectively:
   pausing the presentation of the audio content based on the audio content being presented; or
   resuming the presentation of the audio content based on the audio content being paused; and/or
the controlling of the operation of the computing device comprises providing an input associated with a click or a tap based on the mapping of the recognized gesture to the configuration input primitive.

Example 9: The method of any one of examples 2 to 5, wherein:
the mapping of the recognized gesture to the input primitive comprises mapping the recognized gesture to a dismissal input primitive;
the controlling of the operation of the hearable comprises advancing the audio content to a next track based on the mapping of the recognized gesture to the dismissal input primitive; and/or
the controlling of the operation of the computing device comprises presenting previous content on a display of the computing device based on the mapping of the recognized gesture to the dismissal input primitive.

Example 10: The method of any one of examples 2 to 5, wherein:
the mapping of the recognized gesture to the input primitive comprises mapping the recognized gesture to a custom input primitive;
the controlling of the operation of the hearable comprises enabling voice control based on the mapping of the recognized gesture to the custom input primitive; and/or
the controlling of the operation of the computing device comprises enabling mobile payment 338 based on the mapping of the recognized gesture to the custom input primitive.

Example 11: The method of any previous example, wherein the gesture comprises at least one of the following:
a muscle-based gesture in which the user engages one or more muscles associated with the one or more parts of their upper body; or
an object-based gesture in which the user uses an object or an appendage to touch the one or more parts of their upper body.

Example 12: The method of any previous example, wherein the recognizing the gesture comprises recognizing the gesture based on a change in at least one of an amplitude or a phase of the acoustic receive signal.

Example 13: The method of any previous example, wherein the acoustic transmit signal comprises an ultrasound signal having frequencies between approximately twenty kilohertz and ninety-six kilohertz.

Example 14: The method of any previous example, further comprising:
transmitting audible content during at least a portion of time that the acoustic transmit signal is transmitted.

Example 15: A computer-readable storage medium comprising instructions that, responsive to execution by a processor, cause a hearable to perform any one of the methods of examples 1 to 14.

Example 16: A device comprising:
at least one transducer; and
at least one processor, the device configured to perform, using the at least one transducer and the at least one processor, any one of the methods of examples 1 to 14.

Example 17: The device of example 16, further comprising:
a speaker; and
an active-noise-cancellation circuit comprising a feedback microphone, wherein:
the at least one transducer comprises the speaker and the feedback microphone.

Example 18: The device of example 16, wherein:
the at least one transducer comprises a speaker and a microphone;
the speaker is configured to be positioned proximate to a first ear of a user; and
the microphone is configured to be positioned proximate to a second ear.

Example 19: The device of any one of examples 16 to 18, wherein the device is configured to at least partially seal one or more ears of a user.

Example 20: The device of any one of examples 16 to 19, wherein the device comprises:
at least one earbud; or
headphones.

1. A method comprising:
transmitting, during a first time period, an acoustic transmit signal that propagates within at least a portion of an ear canal of a user;
receiving, during the first time period, an acoustic receive signal, the acoustic receive signal representing a version of the acoustic transmit signal with one or more waveform characteristics modified based on the propagation within the ear canal and based on a gesture performed by the user during the first time period, the gesture associated with the user moving and/or interacting with one or more parts of their upper body; and
recognizing the gesture based on the one or more modified waveform characteristics of the acoustic receive signal; and
controlling an operation of at least one device based on the recognized gesture.

2. The method of claim 1, wherein the controlling the operation of the at least one device comprises at least one of the following:
controlling an operation of a hearable based on the recognized gesture; or
controlling an operation of a computing device based on the recognized gesture.

3. The method of claim 2, further comprising:
determining that gesture-based control of the hearable is enabled; and
responsive to the determination, controlling the operation of the hearable based on the recognized gesture.

4. The method of claim 2, further comprising:
determining that gesture-based control of the hearable is disabled; and
responsive to the determination, controlling the operation of the computing device based on the recognized gesture.

5. The method of claim 3, further comprising:
determining whether gesture-based control of the hearable is enabled or disabled; and,
responsive to the determination, either controlling the operation of the hearable based on the recognized gesture if the gesture-based control of the hearable is enabled, or controlling the operation of the computing device based on the recognized gesture if gesture-based control of the hearable is disabled.

6. The method of claim 2, further comprising:
mapping the recognized gesture to an input primitive, the input primitive comprising a selection input primitive, wherein:
the controlling of the operation of the hearable comprises controlling a volume of the hearable based on the mapping of the recognized gesture to the selection input primitive; and/or
the controlling of the operation of the computing device comprises scrolling through content that is presented on a display of the computing device based on the mapping of the recognized gesture to the selection input primitive.

7. The method of claim 6, wherein:
the controlling the volume of the hearable comprises increase or decreasing the volume of the hearable based on a direction associated with the recognized gesture; and
the scrolling through the content comprises scrolling through the content based on the direction associated with the recognized gesture.

8. The method of claim 2, wherein:
the mapping of the recognized gesture to the input primitive comprises mapping the recognized gesture to a confirmation input primitive;
the controlling of the operation of the hearable comprises controlling a presentation of audible content based on the mapping of the recognized gesture to the confirmation input primitive, the controlling the presentation of the audible content comprising selectively:
pausing the presentation of the audio content based on the audio content being presented; or
resuming the presentation of the audio content based on the audio content being paused; and/or
the controlling of the operation of the computing device comprises providing an input associated with a click or a tap based on the mapping of the recognized gesture to the configuration input primitive.

9. The method of claim 2, wherein:
the mapping of the recognized gesture to the input primitive comprises mapping the recognized gesture to a dismissal input primitive;
the controlling of the operation of the hearable comprises advancing the audio content to a next track based on the mapping of the recognized gesture to the dismissal input primitive; and/or
the controlling of the operation of the computing device comprises presenting previous content on a display of the computing device based on the mapping of the recognized gesture to the dismissal input primitive.

10. The method of claim 2, wherein:
the mapping of the recognized gesture to the input primitive comprises mapping the recognized gesture to a custom input primitive;
the controlling of the operation of the hearable comprises enabling voice control based on the mapping of the recognized gesture to the custom input primitive; and/or
the controlling of the operation of the computing device comprises enabling mobile payment based on the mapping of the recognized gesture to the custom input primitive.

11. The method of claim 1, wherein the gesture comprises at least one of the following:
a muscle-based gesture in which the user engages one or more muscles associated with the one or more parts of their upper body; or
an object-based gesture in which the user uses an object or an appendage to touch the one or more parts of their upper body.

12. The method of claim 1, wherein the recognizing the gesture comprises recognizing the gesture based on a change in at least one of an amplitude or a phase of the acoustic receive signal.

13. The method of claim 1, wherein the acoustic transmit signal comprises an ultrasound signal having frequencies between approximately twenty kilohertz and ninety-six kilohertz.

14. The method of claim 1, further comprising:
transmitting audible content during at least a portion of time that the acoustic transmit signal is transmitted.

15. A computer-readable storage medium comprising instructions that, responsive to execution by a processor, cause a hearable to:
transmit, during a first time period, an acoustic transmit signal that propagates within at least a portion of an ear canal of a user;
receive, during the first time period, an acoustic receive signal, the acoustic receive signal representing a version of the acoustic transmit signal with one or more waveform characteristics modified based on the propagation within the ear canal and based on a gesture performed by the user during the first time period, the gesture associated with the user moving and/or interacting with one or more parts of their upper body; and
recognize the gesture based on the one or more modified waveform characteristics of the acoustic receive signal; and
control an operation of at least one device based on the recognized gesture.

16. A device comprising:
at least one transducer configured to:
transmit, during a first time period, an acoustic transmit signal that propagates within at least a portion of an ear canal of a user; and
receive, during the first time period, an acoustic receive signal, the acoustic receive signal representing a version of the acoustic transmit signal with one or more waveform characteristics modified based on the propagation within the ear canal and based on a gesture performed by the user during the first time period, the gesture associated with the user moving and/or interacting with one or more parts of their upper body; and; and
at least one processor coupled to the at least one transducer, the at least one processor configured to:
recognize the gesture based on the one or more modified waveform characteristics of the acoustic receive signal; and
control an operation of at least one device based on the recognized gesture.

17. The device of claim 16, further comprising:
a speaker; and
an active-noise-cancellation circuit comprising a feedback microphone, wherein:
the at least one transducer comprises the speaker and the feedback microphone.

18. The device of claim 16, wherein:
the at least one transducer comprises a speaker and a microphone;
the speaker is configured to be positioned proximate to a first ear of a user; and
the microphone is configured to be positioned proximate to a second ear.

19. The device of claim 16, wherein the device is configured to at least partially seal one or more ears of a user.

20. The device of claim 16, wherein the device comprises:
at least one earbud; or
headphones.
